(19) United States
(12) Patent Application Publication
(10) Pub. No.: US 2024/0409685 A1
(43) Pub. Date: Dec. 12, 2024

(54) POLYMERS AND METHODS OF USE

(71) Applicants: Regents of the University of Minnesota, Minneapolis, MN (US); THE UNIVERSITY OF NORTH CAROLINA AT CHAPEL HILL, Chapel Hill, NC (US)

(72) Inventors: Ian Albert Tonks, Minneapolis, MN (US); Rachel Maria Rapagnani, Minneapolis, MN (US); Aleksandr Vadymovich Zhukhovitskiy, Chapel Hill, NC (US); Rachael Ann Jedlika Ditzler, Chapel Hill, NC (US); Nathaniel Kaznicki Berney, Chapel Hill, NC (US)

(73) Assignees: Regents of the University of Minnesota, Minneapolis, MN (US); THE UNIVERSITY OF NORTH CAROLINA AT CHAPEL HILL, Chapel Hill, NC (US)

(21) Appl. No.: 18/680,263

(22) Filed: May 31, 2024

Related U.S. Application Data
(60) Provisional application No. 63/470,748, filed on Jun. 2, 2023.

(51) Int. Cl. C08G 63/88; C08G 18/82

(52) U.S. Cl. CPC C08G 63/88; C08G 18/82; C08G 2230/00

(57) ABSTRACT

The present document provides methods for post-polymerization modification of polymer backbones. In particular, the methods described in this document relate to transformation of polyesters and polyurethanes via [3,3]-sigmatropic rearrangement. Polymer compounds containing backbones modified post-polymerization are also provided, along with various methods of using these polymers in a variety of segments of the economy.

### CROSS-REFERENCE TO RELATED APPLICATIONS

This application claims the benefit of U.S. Patent Application Ser. No. 63/470,748, filed on Jun. 2, 2023. The disclosure of the prior application is considered part of (and is incorporated by reference in) the disclosure of this application.

### FEDERALLY SPONSORED RESEARCH OR DEVELOPMENT

This invention was made with government support under CHE1901635, and CHE2203499 awarded by the National Science Foundation. The government has certain rights in the invention.

### TECHNICAL FIELD

This document relates to methods for post-polymerization modification of polymer backbones. In particular, the methods within the present claims relate to transformation of polyesters and polyurethanes via [3,3]-sigmatropic rearrangement.

### BACKGROUND

Polymers are versatile chemical materials useful in a wide array of industries and sectors of the economy. Polymers, such as polyesters and polyurethanes, are extensively utilized commodity plastics in pharmaceutical, agrochemical, electronics, textile, and other industries. Biodegradable polymers, such as those having hydrolytically cleavable ester linkages in repeating units, allow for making environmentally friendly plastics that can be decomposed by living organisms into water and carbon dioxide. As such, biodegradable polymer materials help mitigate plastic waste.

### SUMMARY

Post-polymerization modification (“PPM”) is a pivotal phase of the polymer life-cycle because it enables exponentiation of structural and property diversity in soft materials. Within PPM, the focus has by and large been on side-chains and end-groups; meanwhile. At the same time, editing of polymer backbones offers marked polymer property changes, access to novel repeat units that are not available via classical polymerization strategies, and potential for new and orthogonal degradation pathways. Moreover, most polymer backbone edits are highly backbone-specific, which in turn limits their implementation. The present disclosure provides methods utilizing a ubiquitous monomer substrate (e.g. allylic ester) that advantageously allows to expand the practice of backbone editing. Without being bound to any particular theory, the [3,3] sigmatropic rearrangement described herein for allylic polymer substrates can be applied to many types of polymer backbones (e.g., polyester and polyurethane backbones) in order to change the material properties. Using a cross-metathesis reaction, functionalized allylic ester substrates can be attained, further expanding the chemical and structural variety of alkene-containing polymer backbones following the rearrangement reaction. Hydrogenation of the rearranged polymers provided in this document further expands access to variously substituted vinyl-type polymers that could not be obtained by simple polymerization of functionalized ethylene substrates. Moreover, the rearranged polymer products described herein allow for new and orthogonal degradation pathways providing versatile and environmentally friendly plastic commodities. For example, introduction of the alkene functional group into the polymer backbone itself allows for degradation via ethanolysis/ethenolysis reaction, providing a valuable tool for selective de-polymerization/degradation/separation of rearranged polymer products described in this document in the mixed polymer waste streams.

In some embodiments, the present document provides a polymer compound comprising at least one repeating unit according to Formula (I)

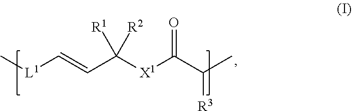

wherein L¹, R¹, R², X¹, and R³ are as described herein.

In some embodiments, the polymer compound comprises at least one repeating unit according to Formula (IA):

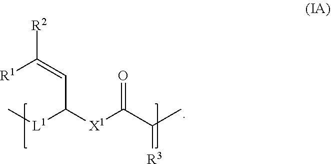

In some embodiments, the present document provides a polymer compound comprising at least one repeating unit according to Formula (II)

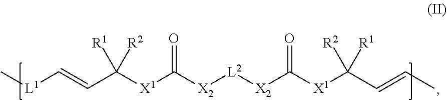

wherein L¹, R¹, R², X¹, X², and L² are as described herein.

In some embodiments, the polymer compound comprises at least one repeating unit according to Formula (IIA):

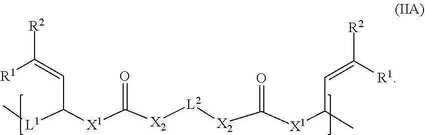

In some embodiments, the present document provides a method of making a polymer compound comprising at least one repeating unit of Formula (I), the method comprising reacting a compound of Formula (IA) (e.g., inducing a [3,3]-sigmatropic rearrangement in the compound of Formula (IA)).

In some embodiments, the present document provides a method of making a polymer compound comprising at least one repeating unit of Formula (II), the method comprising reacting a compound of Formula (IIA) (e.g., inducing a [3,3]-sigmatropic rearrangement in the compound of Formula (IIA)).

In some embodiments, the present document provides a method of using a polymer compound at least one repeating unit according to Formula (I) or Formula (II) in any industry or sector of the economy where such a polymer is useful. For example, the polymer compound may be useful as a (bio)degradable plastic (e.g., plastic bottle or plastic bag material), a fiber component, a fire retardant material, or a coating for a medical device (e.g., heart valve, stent, or catheter).

Unless otherwise defined, all technical and scientific terms used herein have the same meaning as commonly understood by one of ordinary skill in the art to which the present application belongs. Methods and materials are described herein for use in the present application; other, suitable methods and materials known in the art can also be used. The materials, methods, and examples are illustrative only and not intended to be limiting. All publications, patent applications, patents, sequences, database entries, and other references mentioned herein are incorporated by reference in their entirety. In case of conflict, the present specification, including definitions, will control.

Other features and advantages of the present application will be apparent from the following detailed description and figures, and from the claims.

### DESCRIPTION OF DRAWINGS

FIG. 1A contains a synthetic scheme showing Ireland-Claisen rearrangement of polyesters and Brook rearrangement of poly(acyl silane)s.

FIG. 1B contains a synthetic scheme showing [3,3]-sigmatropic rearrangement (e.g., Pd-catalyzed rearrangement) of allylic esters and allylic polyester polymers.

FIG. 2A contains a synthetic scheme showing sigmatropic rearrangement of poly (allyl ester) polymer. Branched-to-linear rearrangement of PE1, PE2, PU1, and PU2 catalyzed with (MeCN)₂PdCl₂.

FIG. 2B contains stacked ¹H NMR spectra of PE1 and crude PE1′ (CDCl₃, 500 MHz, 25° C.).

FIG. 2C contains stacked ¹H NMR spectra of PU1 and crude PU1′ (CDCl₃, 500 MHz, 25° C.).

FIG. 2D contains a line plot showing gel-permeation chromatography with multi-angle light scattering (GPC-MALS) (tetrahydrofuran (THF), 35° C.) differential refractive index (dRI) traces of PE1 (Mₙ=7.55 kDa, Ð=1.21, dn/dc=0.07), PE1′ (Mₙ=8.84 kDa, Ð=1.20, dn/dc=0.07), PU1 (Mₙ=24.6 kDa, Ð=1.40, dn/dc=0.14), and PU1′ Mₙ=43.9 kDa, Ð=1.13, dn/dc=0.16).

FIG. 2E contains a semilogarithmic plot of the equilibrium kinetics of the PE1-to-PE1′ rearrangement, where equilibrium conversion is set to 0.665.

FIG. 2F contains differential scanning calorimetry (DSC) curves before and after rearrangement of PE1.

FIG. 3 contains a table showing functionalized PE1 polymers PE3-7 and subsequent [3,3]-sigmatropic rearrangement with (MeCN)₂PdCl₂. % funx. refers to the conversion of the cross metathesis; % RAR refers to the rearrangement of the unfunctionalized PE segments; % funx. RAR refers to the rearrangement of the functionalized PE segments.

FIG. 4A contains synthetic scheme showing rearrangement and subsequent degradative ethenolysis of PE1.

FIG. 4B contains stacked ¹H NMR spectra of PE1′ and the crude mixture after ethenolysis was performed.

FIG. 5 shows a [3,3]-sigmatropic oxo-rearrangement (SOR) of polyesters and polyurethanes from branched to linear using a Pd(II) catalyst via an acetoxonium intermediate as reported for small molecule esters and carbamates by Henry et al., J. Chem. Soc. D 1971, No. 7, 328. https://doi.org/10.1039/c29710000328.

FIG. 6A shows a [3,3]-sigmatropic rearrangement of poly(allyl ester) polymer branched-to-linear rearrangement of PE1, PE2, PU1, and PU2 catalyzed with (MeCN)₂PdCl₂.

FIG. 6B shows stacked ¹H NMR spectra of PE1 (top) and crude PE1′ (bottom) (CDCl₃, 500 MHz, 25° C.).

FIG. 6C shows stacked ¹H NMR spectra of PU1 (top) and crude PU1′ (bottom) (CDCl₃, 500 MHz, 25° C.).

FIG. 6D shows a line plot showing gel-permeation chromatography with multi-angle light scattering (GPC-MALS) (tetrahydrofuran (THF), 35° C.) differential refractive index (dRI) traces of PE1 (red, Mₙ=7.55 kDa, Ð=1.21, dn/dc=0.0768), PE1′ (maroon, Mₙ=8.84 kDa, Ð=1.20, dn/dc=0.0795), PU1 (blue, Mₙ=22.3 kDa, Ð=1.66, dn/dc=0.144), and PU1′ (navy, Mₙ=23.9 kDa, Ð=1.43, dn/dc=0.196).

FIG. 6E shows a semilogarithmic plot of the equilibrium kinetics of the PE1-to-PE1′ rearrangement (top), where equilibrium conversion is set to 0.665 and plot of pseudo zero-order kinetics of the PU1-to-PU1′ rearrangement (bottom—the point marked with * is excluded, as the reaction had reached terminal conversion, [M] refers to concentration of PU1′).

FIG. 6F shows a differential scanning calorimetry (DSC) curves before (red, blue) and after (maroon, navy) rearrangement of PE1 and PU1, respectively.

FIG. 7 shows the SOR of polyester PE1 and functionalized polyesters PE3 and PE4 (Mₙ=14.8 kDa, Ð=1.11 for PE1 used in the cross-metathesis reaction to afford PE3 and PE4). % rearr. A refers to the rearrangement of the unfunctionalized PE segments; % rearr. B refers to the rearrangement of the functionalized PE segments (FIGS. 6B, 6D); ΔG_{B}°, the calculated for SOR of segment B, was calculated by DFT computations on one representative monomer unit of each polymer, with a 6-311+g(d,p) basis set and M06-2X functional.

FIG. 8A. SOR and subsequent degradative ethenolysis of PE1.

FIG. 8B. Stacked 1H NMR spectra of PE1′ (top, maroon) and the crude mixture after ethenolysis was performed (bottom, black).

FIG. 8C. GPC-MALS dRI traces before (maroon, Mₙ=22.8 kDa, Ð=1.39) and after ethenolysis (black, Mₙ=0.85 kDa, Ð=1.25) of PE1′.

FIG. 9A. SOR of PU3 to PU3′ catalyzed by (MeCN)₂PdCl₂.

FIG. 9B. Differential scanning calorimetry (DSC) curves comparing PU3 (blue) and PU3′ (purple); light blue shaded area corresponds to area under the melting peak used to calculate ΔHm.

FIG. 9C. Powder X-ray diffraction (PXRD) of PU3 (blue) and PU3′ (purple) with the distance corresponding to the major peak listed.

FIG. 9D. Multiple uniaxial tensile test trials for PU3 (blue hues) and PU3′ (purple hues).

### DETAILED DESCRIPTION

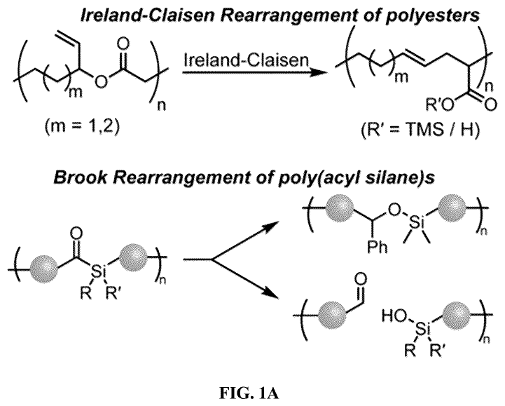

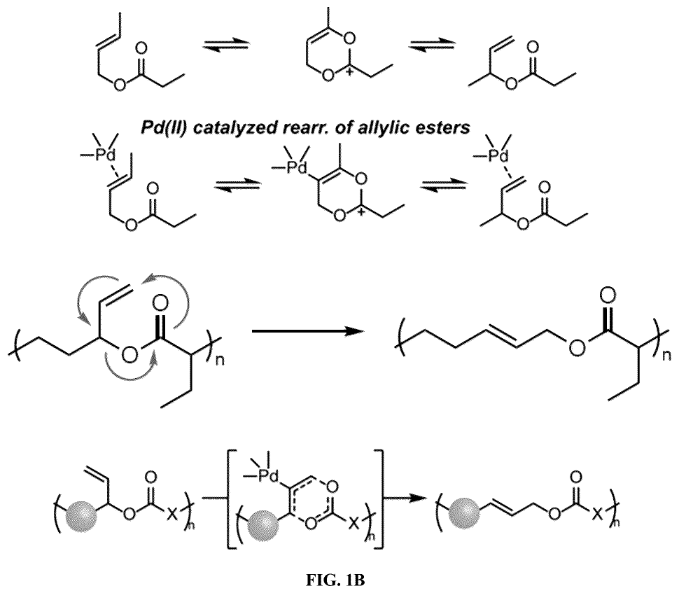

Sigmatropic rearrangements-migrations of a s-bond adjacent to a p-system constitute particularly powerful chemistry for polymer backbone editing:over a century of research in the context of small molecules and, more recently, polymers has shown that these reactions can dramatically transform the identity of a molecular skeleton, engage strong carbon-carbon and carbon-heteroatom bonds, and obviate deleterious chain cleavage. For example, anionic and photochemical 1,2-Brook rearrangements can be used to transform poly(acyl silane)s to poly(silyl ether)s and for controlled backbone degradation respectively, and Ireland-Claisen rearrangement of vinyl-substituted polyesters can be used to produce vinyl polymers (See FIG. 1A). However, a key limitation of these examples is the lack of generality: the Brook rearrangement is particular to acyl silane functionality, and the Ireland-Claisen rearrangement requires allylic esters.

The present document describes a [3,3]-sigmatropic rearrangement (e.g., a transition metal-catalyzed rearrangement), which proceeds rapidly and cleanly with both allylic esters in polyesters and allylic carbamates in polyurethanes. Without being bound by any theory or speculation, a mechanism of the [3,3]-sigmatropic rearrangement by isomerization/equilibration via the formation of a cyclic acetoxonium intermediate is schematically shown in FIG. 1B. In this reaction, acetonitrile and benzonitrile complexes of PdCl₂ can be used as catalysts, which enhance the rate of isomerization by 10¹³-10¹⁴ compared to the uncatalyzed reaction. In one example, the experimental data provided in this disclosure shows that this and similar catalytic systems are similarly effective to isomerize branched polyester and polyurethane backbones into linear ones or vice versa, e.g., as dictated by thermodynamics.

In one general aspect, the present disclosure provides a polymer compound comprising at least one repeating unit according to Formula (I) or Formula (II):

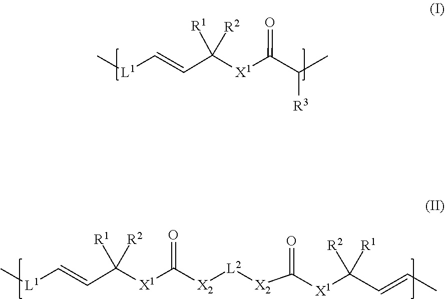

wherein:
each L¹ is independently selected from C₁₋₆ alkylene, C₆₋₁₀ arylene, C₃₋₁₀ cycloalkylene, 5-14 membered heteroarylene, and 4-10 membered heterocycloalkylene;
each L² is independently selected from C₁₋₁₂ alkylene, C₆₋₁₀ arylene, C₃₋₁₀ cycloalkylene, 5-14 membered heteroarylene, and 4-10 membered heterocycloalkylene, each of which is optionally substituted with 1, 2, or 3 substituents independently selected from C₁₋₁₂ alkyl, halo, CN, C₁₋₆ haloalkyl, C₂₋₆ alkenyl, C₂₋₆ alkynyl, C(O)NR^{c1}R^{d1}, C(O)OR^{a1}, and C(O)R^{b1};
each X¹ is independently selected from O and NR^{N};
each X² is independently selected from O and NR^{N};
each R^{N} is independently selected from H and C₁₋₃ alkyl;
each R¹ is independently selected from H, Cy¹, halo, CN, C₁₋₆ alkyl, C₁₋₆ haloalkyl, C₂₋₆ alkenyl, C₂₋₆ alkynyl, C(O)NR^{c1}R^{d1}, C(O)OR^{a1}, C(O)R^{b1}, S(O)₂R^{b1}, S(O)₂NR^{c1}R^{d1}, S(O)₂OR^{a1}, P(O)(OR^{a1})₂, and B(OR^{a1})₂, wherein said C₁₋₆ alkyl is optionally substituted with Cy¹, halo, CN, C(O)NR^{c1}R^{d1}, C(O)OR^{a1}, C(O)R^{b1}, S(O)₂R^{b1}, S(O)₂NR^{c1}R^{d1}, S(O)₂OR^{a1}, or P(O)(OR^{a1})₂;
each R² is independently selected from H, Cy¹, halo, CN, C₁₋₆ alkyl, C₁₋₆ haloalkyl, C₂₋₆ alkenyl, C₂₋₆ alkynyl, C(O)NR^{c1}R^{d1}, C(O)OR^{a1}, C(O)R^{b1}, S(O)₂R^{b1}, S(O)₂NR^{c1}R^{d1} S(O)₂OR^{a1}, P(O)(OR^{a1})₂, and B(OR^{a1})₂, wherein said C₁₋₆ alkyl is optionally substituted with Cy¹, halo, CN, C(O)NR^{c1}R^{d1}, C(O)OR^{a1}, C(O)R^{b1}, S(O)₂R^{b1}, S(O)₂NR^{c1}R^{d1}, S(O)₂OR^{a1}, or P(O)(OR^{a1})₂;
or R¹ and R² together with the carbon atom to which they are attached form a C₃₋₁₀ cycloalkyl ring or a 4-10 membered heterocycloalkyl ring, each of which is optionally substituted with 1 or 2 substituents independently selected from halo, CN, C_{1*3} alkyl, C₁₋₃ haloalkyl, C(O)NR^{c1}R^{d1}, and C(O)OR^{a1};
R³ is selected from H and C₁₋₃ alkyl;
each Cy¹ is independently selected from C₆₋₁₀ aryl, C₃₋₁₀ cycloalkyl, 5-10 membered heteroaryl, and 4-10 membered heterocycloalkyl, each of which is optionally substituted with 1 or 2 substituents independently selected from R^{Cy};
each R^{Cy} is independently selected from halo, C₁₋₃ alkyl, C₁₋₃ haloalkyl, halo, CN, NO₂, C₁₋₃ alkoxy, C₁₋₃ haloalkoxy, amino, C₁₋₃ alkylamino, di(C₁₋₃ alkyl)amino, carboxy, and C₁₋₃ alkoxycarbonyl;
each R^{a1}, R^{b1}, R^{c1}, and R^{d1} is independently selected from H, C₁₋₃ alkyl, and C₁₋₃ haloalkyl; and
any two adjacent R^{a1} together form C₂₋₈ alkylene, C₆₋₁₀ arylene, C₃₋₁₀ cycloalkylene, 5-14 membered heteroarylene, or 4-10 membered heterocycloalkylene.

In some embodiments, the polymer compound comprises at least one repeating unit of Formula (I):

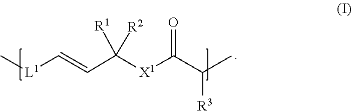

In some embodiments, the polymer compound comprises at least one repeating unit of Formula (IA):

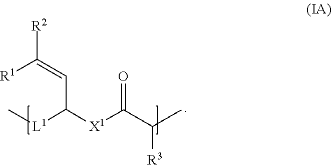

In some embodiments, L¹ is C₁₋₆ alkylene.

In some embodiments, L¹ is selected from methylene, ethylene, and propylene.

In some embodiments, X¹ is O.

In some embodiments, X¹ is NH.

In some embodiments, the polymer compound comprises at least one repeating unit of formula:

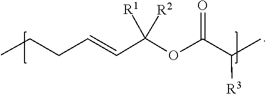

In some embodiments, the polymer compound comprises at least one repeating unit of formula:

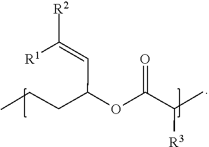

In some embodiments, R³ is H.

In some embodiments, R³ is C₁₋₃ alkyl.

In some embodiments:
R¹ is H; and
R² is selected from Cy¹, C₁₋₆ alkyl, C₂₋₆ alkenyl, C(O)OR^{a1}, and B(OR^{a1})₂.

In some embodiments, R¹ and R² together with the carbon atom to which they are attached form a C₃₋₁₀ cycloalkyl ring.

In some embodiments, the C₃₋₁₀ cycloalkyl ring is selected from cyclopropyl, cyclobutyl, cyclopentyl, and cyclohexyl.

In some embodiments, the repeating unit of Formula (I) is selected from any one of the following formulae:

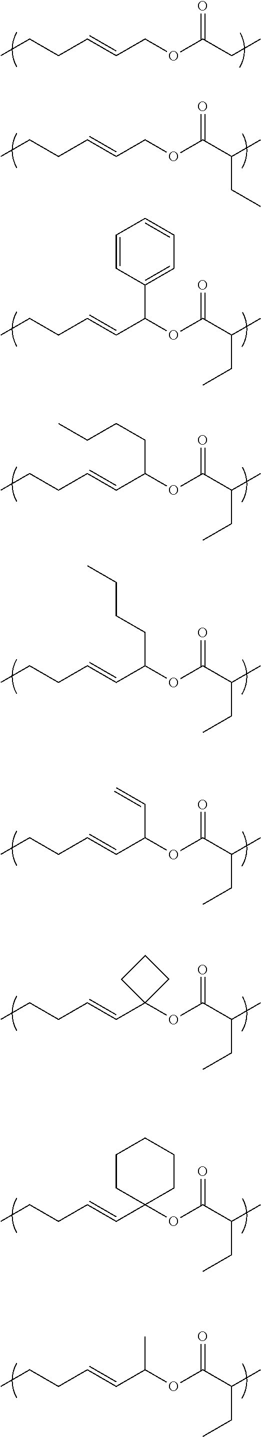

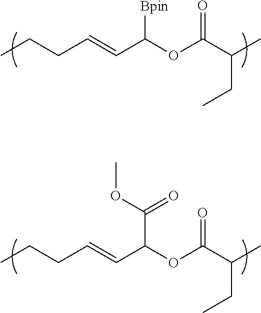

In some embodiments, the polymer compound comprises a repeating unit of any one of the following formulae:

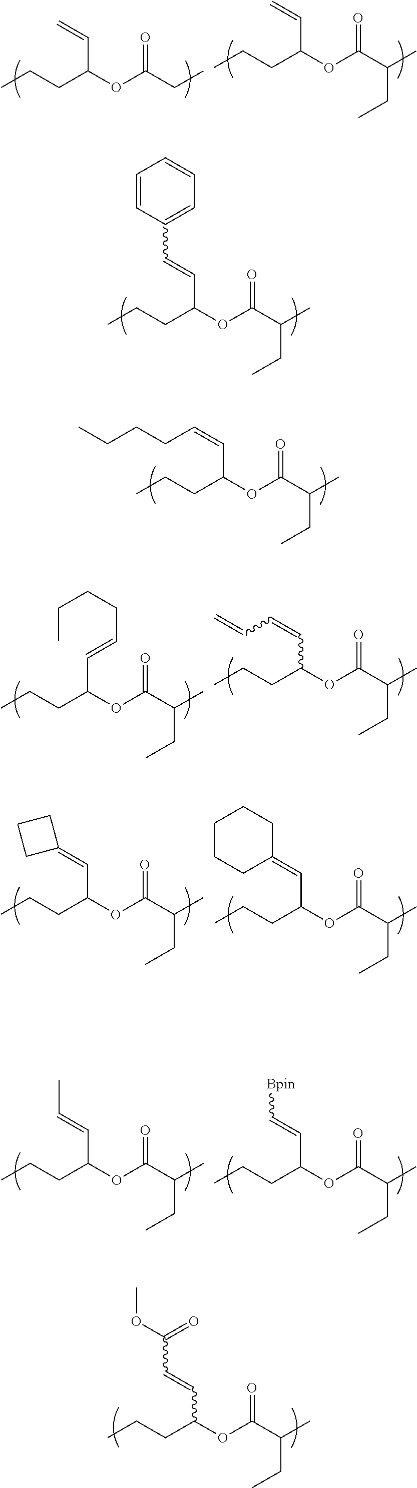

In some embodiments, the polymer compound comprises at least one repeating unit of Formula (II):

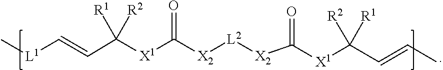

In some embodiments, the polymer compound comprises at least one repeating unit of Formula (IIA):

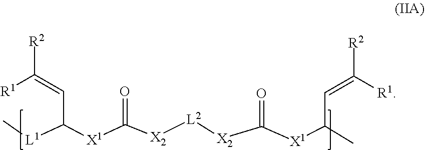

In some embodiments, L¹ is C₁₋₆ alkylene.

In some embodiments, L¹ is selected from methylene, ethylene, and propylene.

In some embodiments, L¹ is C₆₋₁₀ arylene.

In some embodiments, L¹ is phenylene.

In some embodiments, X¹ is O.

In some embodiments, X¹ is NH.

In some embodiments, X² is O.

In some embodiments, X² is NH.

In some embodiments, the polymer compound comprises at least one repeating unit of formula:

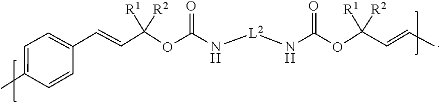

In some embodiments, the polymer compound comprises at least one repeating unit of formula:

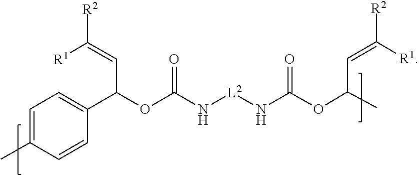

In some embodiments:
R¹ is H; and
R² is selected from Cy¹, C₁₋₆ alkyl, C₂₋₆ alkenyl, C(O)OR^{a1}, and B(OR^{a1})₂.

In some embodiments, R¹ and R² together with the carbon atom to which they are attached form a C₃₋₁₀ cycloalkyl ring.

In some embodiments, the C₃₋₁₀ cycloalkyl ring is selected from cyclopropyl, cyclobutyl, cyclopentyl, and cyclohexyl.

In some embodiments, L² is C₁₋₁₂ alkylene

In some embodiments, L² is C₆₋₁₂ alkylene.

In some embodiments, L² is n-hexylene.

In some embodiments, L² is C₆₋₁₄ arylene optionally substituted with 1 or 2 substituents independently selected from C₁₋₁₂ alkyl, halo, CN, C₁₋₆ haloalkyl, C₂₋₆ alkenyl, and C₂₋₆ alkynyl.

In some embodiments, the repeating unit of Formula (II) is selected from any one of the following formulae:

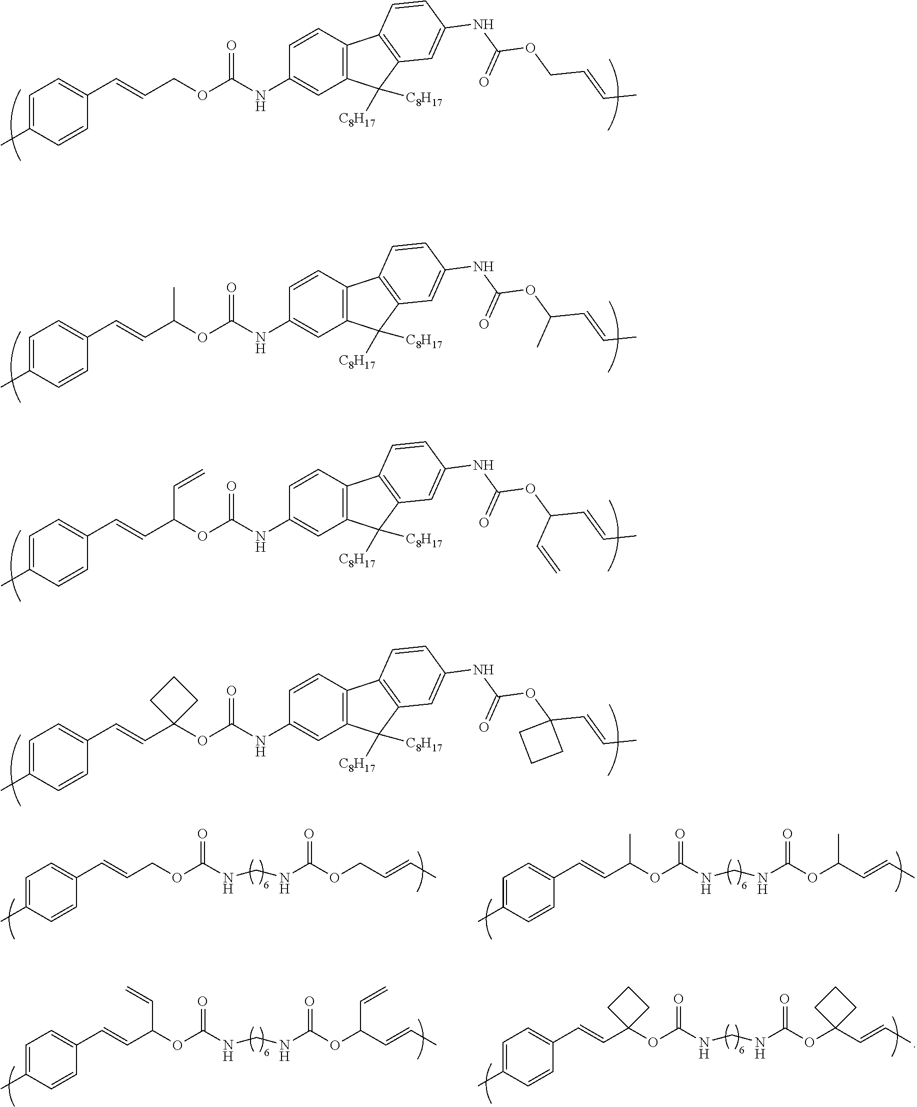

In some embodiments, a repeating unit of any one of the following formulae:

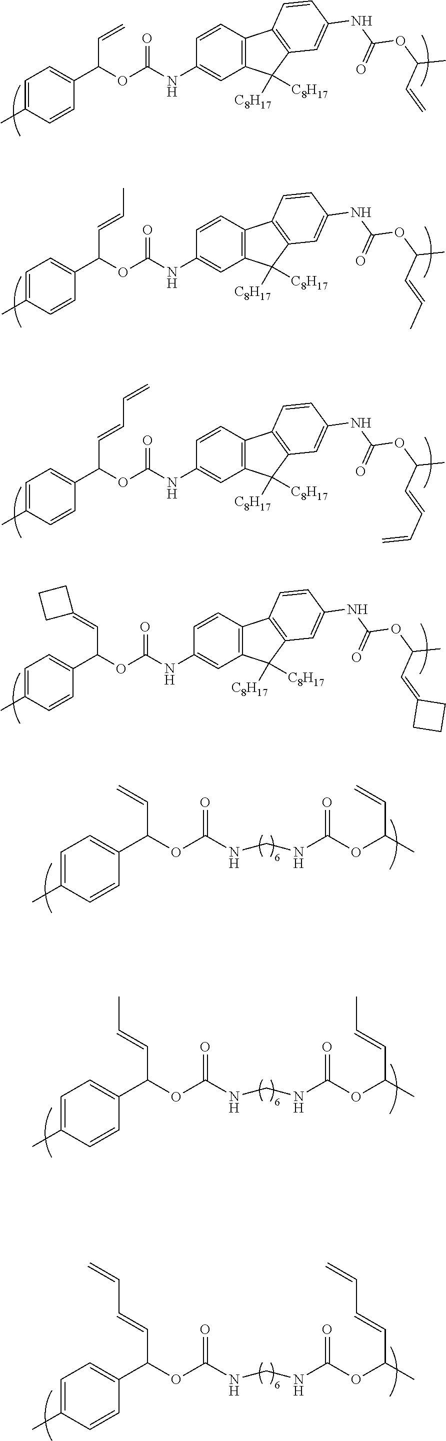

In one general aspect, the present disclosure provides a method of making a polymer compound comprising at least one repeating unit of Formula (I):

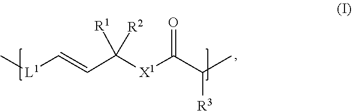

the method comprising reacting a compound of Formula (IA):

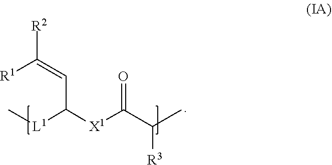

to obtain the compound of Formula (I),
wherein L¹, R¹ R², X¹, and R³ in Formulae (I) and (IA) are as described herein.

In one general aspect, the present disclosure provides a method of making a polymer compound comprising at least one repeating unit of Formula (II):

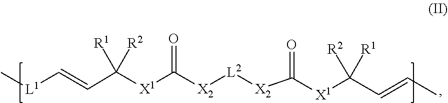

the method comprising reacting a compound of Formula (IIA):

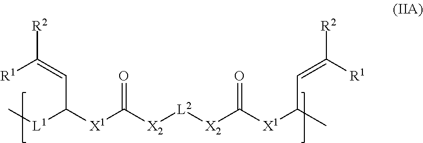

to obtain the compound of Formula (II),
wherein L¹, R¹ R², X¹, X², and L² in Formulae (II) and (IIA) are as described herein.

In some embodiments, reacting comprises inducing a [3,3]-sigmatropic rearrangement in the compound of Formula (IA). In some embodiments, reacting comprises inducing a [3,3]-sigmatropic rearrangement in the compound of Formula (IIA).

In some embodiments, the number of repeating units is from 1 to 6,500, such as from 1 to 1,000, such as from 1 to 650, such as from 10 to 650, such as from 100 to 650.

In some embodiments, about 0.1% to about 100% of the repeating units undergo a [3,3]-sigmatropic rearrangement. In some embodiments, about 1% to about 100%, such as about 10% to about 100%, such as about 50% to about 100%, of the repeating units undergo a [3,3]-sigmatropic rearrangement.

In some embodiments, the reacting is carried out at a temperature from about 15° C. to about 65° C. In some embodiments, the reacting is carried out at a temperature of about 20° C., about 25° C., about 30° C., about 35° C., about 40° C., about 45° C., about 50° C., or about 55° C. In some embodiments, the reacting is carried out at about room temperature (e.g., ambient temperature).

In some embodiments, the reacting is carried out in a liquid phase (e.g., neat or in a solvent). In some embodiments, the reacting is carried out in a solvent, such as dichloromethane, chloroform, dioxane, tetrahydrofuran, dimethylsulfoxide, or dimethylformamide.

In some embodiments, the time of the reacting is from about 1 hour to about 12 hours. In some embodiments, the time of reacting is about 1 hour, about 1.5 hours, about 2 hours, about 3 hours, about 4 hours, about 5 hours, or about 6 hours.

In some embodiments, the reacting is carried out in the presence of a catalyst. In some embodiments, the catalyst is an organic catalyst or a transition metal catalyst. In some embodiment, the catalyst is a Lewis acid or a Bronsted acid. In some embodiments, the catalyst is a transition metal catalyst. In some embodiments, the transition metal is selected from Pd, Cu, Ni, Co, Ru, and Fe. In some embodiments, the transition metal is Pd. In some embodiments, the catalyst is selected from Pd(dba)₂, P(o-OMePh), (MeCN)₂PdCl₂, (PhCN)₂PdCl₂, Pd⁰, and Pd/C. In some embodiments, the catalyst is selected from (MeCN)₂PdCl₂ and (PhCN)₂PdCl₂.

In some embodiments, the polymer compound is hydrophilic, hydrophobic, or amphiphilic. In some embodiments, the polymer compound is flexible. In some embodiments, the polymer compound is rigid. In some embodiments, the polymer compound is capable of forming a foam (e.g., in the presence of a foaming agent such as CO₂ or N₂). In some embodiments, the present document provides a method of using a polymer compound at least one repeating unit according to Formula (I) (and/or Formula (IA)) any industry or sector of the economy where such a polymer is useful. In some embodiments, the present document provides a method of using a polymer compound at least one repeating unit according to Formula (II) (and/or Formula (IIA)) any industry or sector of the economy where such a polymer is useful. For example, the polymer compound may be useful as a (bio)degradable plastic (e.g., plastic bottle or plastic bag material). In another example, the polymer may be useful as a fiber component (e.g., for making a yarn), a fire retardant material (e.g., for impregnating textiles), or a coating for a medical device (e.g., heart valve, stent, or catheter). In yet another example, the polymer compound of this document can be useful as thermoplastic, thermoset, or elastomer. The polymer compound can also be useful as a coating for kitchenware, making pipes, electrical insulation, or making semiconductors.

### Definitions

As used herein, the term “about” means “approximately” (e.g., plus or minus approximately 10% of the indicated value).

At various places in the present specification, substituents of compounds of the invention are disclosed in groups or in ranges. It is specifically intended that the invention include each and every individual subcombination of the members of such groups and ranges. For example, the term “C₁₋₆ alkyl” is specifically intended to individually disclose methyl, ethyl, C₃ alkyl, C₄ alkyl, C₅ alkyl, and C₆ alkyl.

At various places in the present specification various aryl, heteroaryl, cycloalkyl, and heterocycloalkyl rings are described. Unless otherwise specified, these rings can be attached to the rest of the molecule at any ring member as permitted by valency. For example, the term “a pyridine ring” or “pyridinyl” may refer to a pyridin-2-yl, pyridin-3-yl, or pyridin-4-yl ring.

It is further appreciated that certain features of the invention, which are, for clarity, described in the context of separate embodiments, can also be provided in combination in a single embodiment. Conversely, various features of the invention which are, for brevity, described in the context of a single embodiment, can also be provided separately or in any suitable subcombination.

The term “aromatic” refers to a carbocycle or heterocycle having one or more polyunsaturated rings having aromatic character (i.e., having (4n+2) delocalized π (pi) electrons where n is an integer).

The term “n-membered” where n is an integer typically describes the number of ring-forming atoms in a moiety where the number of ring-forming atoms is n. For example, piperidinyl is an example of a 6-membered heterocycloalkyl ring, pyrazolyl is an example of a 5-membered heteroaryl ring, pyridyl is an example of a 6-membered heteroaryl ring, and 1,2,3,4-tetrahydro-naphthalene is an example of a 10-membered cycloalkyl group.

As used herein, the phrase “optionally substituted” means unsubstituted or substituted. The substituents are independently selected, and substitution may be at any chemically accessible position. As used herein, the term “substituted” means that a hydrogen atom is removed and replaced by a substituent. A single divalent substituent, e.g., oxo, can replace two hydrogen atoms. It is to be understood that substitution at a given atom is limited by valency.

Throughout the definitions, the term “C-m” indicates a range which includes the endpoints, wherein n and m are integers and indicate the number of carbons. Examples include C₁₋₄, C₁₋₆, and the like.

As used herein, the term “Cₙ₋ₘ alkyl”, employed alone or in combination with other terms, refers to a saturated hydrocarbon group that may be straight-chain or branched, having n to m carbons. Examples of alkyl moieties include, but are not limited to, chemical groups such as methyl, ethyl, n-propyl, isopropyl, n-butyl, tert-butyl, isobutyl, sec-butyl; higher homologs such as 2-methyl-1-butyl, n-pentyl, 3-pentyl, n-hexyl, 1,2,2-trimethylpropyl, and the like. In some embodiments, the alkyl group contains from 1 to 6 carbon atoms, from 1 to 4 carbon atoms, from 1 to 3 carbon atoms, or 1 to 2 carbon atoms.

As used herein, the term “Cₙ₋ₘ haloalkyl”, employed alone or in combination with other terms, refers to an alkyl group having from one halogen atom to 2s+1 halogen atoms which may be the same or different, where “s” is the number of carbon atoms in the alkyl group, wherein the alkyl group has n to m carbon atoms. In some embodiments, the haloalkyl group is fluorinated only. In some embodiments, the alkyl group has 1 to 6, 1 to 4, or 1 to 3 carbon atoms.

As used herein, “Cₙ₋ₘ alkenyl” refers to an alkyl group having one or more double carbon-carbon bonds and having n to m carbons. Example alkenyl groups include, but are not limited to, ethenyl, n-propenyl, isopropenyl, n-butenyl, sec-butenyl, and the like. In some embodiments, the alkenyl moiety contains 2 to 6, 2 to 4, or 2 to 3 carbon atoms.

As used herein, “Cₙ₋ₘ alkynyl” refers to an alkyl group having one or more triple carbon-carbon bonds and having n to m carbons. Example alkynyl groups include, but are not limited to, ethynyl, propyn-1-yl, propyn-2-yl, and the like. In some embodiments, the alkynyl moiety contains 2 to 6, 2 to 4, or 2 to 3 carbon atoms.

As used herein, the term “Cₙ₋ₘ alkylene”, employed alone or in combination with other terms, refers to a divalent alkyl linking group having n to m carbons. Examples of alkylene groups include, but are not limited to, ethan-1,1-diyl, ethan-1,2-diyl, propan-1,1,-diyl, propan-1,3-diyl, propan-1,2-diyl, butan-1,4-diyl, butan-1,3-diyl, butan-1,2-diyl, 2-methyl-propan-1,3-diyl, and the like. In some embodiments, the alkylene moiety contains 2 to 6, 2 to 4, 2 to 3, 1 to 6, 1 to 4, or 1 to 2 carbon atoms.

As used herein, the term “Cₙ₋ₘ alkoxy”, employed alone or in combination with other terms, refers to a group of formula —O-alkyl, wherein the alkyl group has n to m carbons. Example alkoxy groups include, but are not limited to, methoxy, ethoxy, propoxy (e.g., n-propoxy and isopropoxy), butoxy (e.g., n-butoxy and tert-butoxy), and the like. In some embodiments, the alkyl group has 1 to 6, 1 to 4, or 1 to 3 carbon atoms.

As used herein, “Cₙ₋ₘ haloalkoxy” refers to a group of formula —O-haloalkyl having n to m carbon atoms. An example haloalkoxy group is OCF₃. In some embodiments, the haloalkoxy group is fluorinated only. In some embodiments, the alkyl group has 1 to 6, 1 to 4, or 1 to 3 carbon atoms.

As used herein, the term “amino” refers to a group of formula —NH₂.

As used herein, the term “Cₙ₋ₘ alkylamino” refers to a group of formula —NH(alkyl), wherein the alkyl group has n to m carbon atoms. In some embodiments, the alkyl group has 1 to 6, 1 to 4, or 1 to 3 carbon atoms. Examples of alkylamino groups include, but are not limited to, N-methylamino, N-ethylamino, N-propylamino (e.g., N-(n-propyl)amino and N-isopropylamino), N-butylamino (e.g., N-(n-butyl)amino and N-(tert-butyl)amino), and the like.

As used herein, the term “di(Cₙ₋ₘ-alkyl)amino” refers to a group of formula —N(alkyl)₂, wherein the two alkyl groups each has, independently, n to m carbon atoms. In some embodiments, each alkyl group independently has 1 to 6, 1 to 4, or 1 to 3 carbon atoms.

As used herein, the term “Cₙ₋ₘ alkoxycarbonyl” refers to a group of formula —C(O)O-alkyl, wherein the alkyl group has n to m carbon atoms. In some embodiments, the alkyl group has 1 to 6, 1 to 4, or 1 to 3 carbon atoms. Examples of alkoxycarbonyl groups include, but are not limited to, methoxycarbonyl, ethoxycarbonyl, propoxycarbonyl (e.g., n-propoxycarbonyl and isopropoxycarbonyl), butoxycarbonyl (e.g., n-butoxycarbonyl and tert-butoxycarbonyl), and the like.

As used herein, the term “carboxy” refers to a —C(O)OH group.

As used herein, “halo” refers to F, Cl, Br, or I. In some embodiments, a halo is F, Cl, or Br.

As used herein, the term “aryl,” employed alone or in combination with other terms, refers to an aromatic hydrocarbon group, which may be monocyclic or polycyclic (e.g., having 2, 3 or 4 fused rings). The term “Cₙ₋ₘ aryl” refers to an aryl group having from n to m ring carbon atoms. Aryl groups include, e.g., phenyl, naphthyl, anthracenyl, phenanthrenyl, indanyl, indenyl, and the like. In some embodiments, aryl groups have from 6 to 10 carbon atoms. In some embodiments, the aryl group is phenyl or naphtyl.

As used herein, “cycloalkyl” refers to non-aromatic cyclic hydrocarbons including cyclized alkyl and/or alkenyl groups. Cycloalkyl groups can include mono- or polycyclic (e.g., having 2, 3 or 4 fused rings) groups and spirocycles. Ring-forming carbon atoms of a cycloalkyl group can be optionally substituted by 1 or 2 independently selected oxo or sulfide groups (e.g., C(O) or C(S)). Also included in the definition of cycloalkyl are moieties that have one or more aromatic rings fused (i.e., having a bond in common with) to the cycloalkyl ring, for example, benzo or thienyl derivatives of cyclopentane, cyclohexane, and the like. A cycloalkyl group containing a fused aromatic ring can be attached through any ring-forming atom including a ring-forming atom of the fused aromatic ring. Cycloalkyl groups can have 3, 4, 5, 6, 7, 8, 9, or 10 ring-forming carbons (C₃₋₁₀). In some embodiments, the cycloalkyl is a C₃₋₁₀ monocyclic or bicyclic cyclocalkyl. In some embodiments, the cycloalkyl is a C₃₋₇ monocyclic cyclocalkyl. Example cycloalkyl groups include cyclopropyl, cyclobutyl, cyclopentyl, cyclohexyl, cycloheptyl, cyclopentenyl, cyclohexenyl, cyclohexadienyl, cycloheptatrienyl, norbornyl, norpinyl, norcarnyl, adamantyl, and the like. In some embodiments, cycloalkyl is cyclopropyl, cyclobutyl, cyclopentyl, or cyclohexyl.

As used herein, “heteroaryl” refers to a monocyclic or polycyclic aromatic heterocycle having at least one heteroatom ring member selected from sulfur, oxygen, and nitrogen. In some embodiments, the heteroaryl ring has 1, 2, 3, or 4 heteroatom ring members independently selected from nitrogen, sulfur and oxygen. In some embodiments, any ring-forming N in a heteroaryl moiety can be an N-oxide. In some embodiments, the heteroaryl is a 5-10 membered monocyclic or bicyclic heteroaryl having 1, 2, 3 or 4 heteroatom ring members independently selected from nitrogen, sulfur and oxygen. In some embodiments, the heteroaryl is a 5-6 monocyclic heteroaryl having 1 or 2 heteroatom ring members independently selected from nitrogen, sulfur and oxygen. In some embodiments, the heteroaryl is a five-membered or six-membered heteroaryl ring. A five-membered heteroaryl ring is a heteroaryl with a ring having five ring atoms wherein one or more (e.g., 1, 2, or 3) ring atoms are independently selected from N, O, and S. Exemplary five-membered ring heteroaryls are thienyl, furyl, pyrrolyl, imidazolyl, thiazolyl, oxazolyl, pyrazolyl, isothiazolyl, isoxazolyl, 1,2,3-triazolyl, tetrazolyl, 1,2,3-thiadiazolyl, 1,2,3-oxadiazolyl, 1,2,4-triazolyl, 1,2,4-thiadiazolyl, 1,2,4-oxadiazolyl, 1,3,4-triazolyl, 1,3,4-thiadiazolyl, and 1,3,4-oxadiazolyl. A six-membered heteroaryl ring is a heteroaryl with a ring having six ring atoms wherein one or more (e.g., 1, 2, or 3) ring atoms are independently selected from N, O, and S. Exemplary six-membered ring heteroaryls are pyridyl, pyrazinyl, pyrimidinyl, triazinyl and pyridazinyl.

As used herein, “heterocycloalkyl” refers to non-aromatic monocyclic or polycyclic heterocycles having one or more ring-forming heteroatoms selected from O, N, or S. Included in heterocycloalkyl are monocyclic 4-, 5-, 6-, 7-, 8-, 9- or 10-membered heterocycloalkyl groups. Heterocycloalkyl groups can also include spirocycles. Example heterocycloalkyl groups include pyrrolidin-2-one, 1,3-isoxazolidin-2-one, pyranyl, tetrahydropuran, oxetanyl, azetidinyl, morpholino, thiomorpholino, piperazinyl, tetrahydrofuranyl, tetrahydrothienyl, piperidinyl, pyrrolidinyl, isoxazolidinyl, isothiazolidinyl, pyrazolidinyl, oxazolidinyl, thiazolidinyl, imidazolidinyl, azepanyl, benzazapene, and the like. Ring-forming carbon atoms and heteroatoms of a heterocycloalkyl group can be optionally substituted by 1 or 2 independently selected oxo or sulfido groups (e.g., C(O), S(O), C(S), or S(O)₂, etc.). The heterocycloalkyl group can be attached through a ring-forming carbon atom or a ring-forming heteroatom. In some embodiments, the heterocycloalkyl group contains 0 to 3 double bonds. In some embodiments, the heterocycloalkyl group contains 0 to 2 double bonds. Also included in the definition of heterocycloalkyl are moieties that have one or more aromatic rings fused (i.e., having a bond in common with) to the cycloalkyl ring, for example, benzo or thienyl derivatives of piperidine, morpholine, azepine, etc. A heterocycloalkyl group containing a fused aromatic ring can be attached through any ring-forming atom including a ring-forming atom of the fused aromatic ring. In some embodiments, the heterocycloalkyl is a monocyclic 4-6 membered heterocycloalkyl having 1 or 2 heteroatoms independently selected from nitrogen, oxygen, or sulfur and having one or more oxidized ring members. In some embodiments, the heterocycloalkyl is a monocyclic or bicyclic 4-10 membered heterocycloalkyl having 1, 2, 3, or 4 heteroatoms independently selected from nitrogen, oxygen, or sulfur and having one or more oxidized ring members.

The term “compound” as used herein is meant to include all stereoisomers, geometric isomers, tautomers, and isotopes of the structures depicted. Compounds herein identified by name or structure as one particular tautomeric form are intended to include other tautomeric forms unless otherwise specified.

The compounds described herein can be asymmetric (e.g., having one or more stereocenters). All stereoisomers, such as enantiomers and diastereomers, are intended unless otherwise indicated. Compounds of the present invention that contain asymmetrically substituted carbon atoms can be isolated in optically active or racemic forms. Methods on how to prepare optically active forms from optically inactive starting materials are known in the art, such as by resolution of racemic mixtures or by stereoselective synthesis. Many geometric isomers of olefins, C═N double bonds, N═N double bonds, and the like can also be present in the compounds described herein, and all such stable isomers are contemplated in the present invention. Cis and trans geometric isomers of the compounds of the present invention are described and may be isolated as a mixture of isomers or as separated isomeric forms. In some embodiments, the compound has the (R)-configuration. In some embodiments, the compound has the (S)-configuration.

Compounds provided herein also include tautomeric forms. Tautomeric forms result from the swapping of a single bond with an adjacent double bond together with the concomitant migration of a proton. Tautomeric forms include prototropic tautomers which are isomeric protonation states having the same empirical formula and total charge. Example prototropic tautomers include ketone-enol pairs, amide-imidic acid pairs, lactam-lactim pairs, enamine-imine pairs, and annular forms where a proton can occupy two or more positions of a heterocyclic system, for example, 1H- and 3H-imidazole, 1H-, 2H- and 4H-1,2,4-triazole, 1H- and 2H-isoindole, and 1H- and 2H-pyrazole. Tautomeric forms can be in equilibrium or sterically locked into one form by appropriate substitution.

### EXAMPLES

### Materials and Methods Solvents and reagents were purchased from commercial sources and were used

without further purification unless otherwise noted. Deuterated solvents for NMR such as chloroform (CDCl₃) were purchased from commercial sources and used without further purification. All polymerizations were carried out in a nitrogen-filled glovebox (VAC) unless otherwise specified. Column chromatography was performed using normal-phase silica unless otherwise noted.

### Example 1—Preparation of PE1′

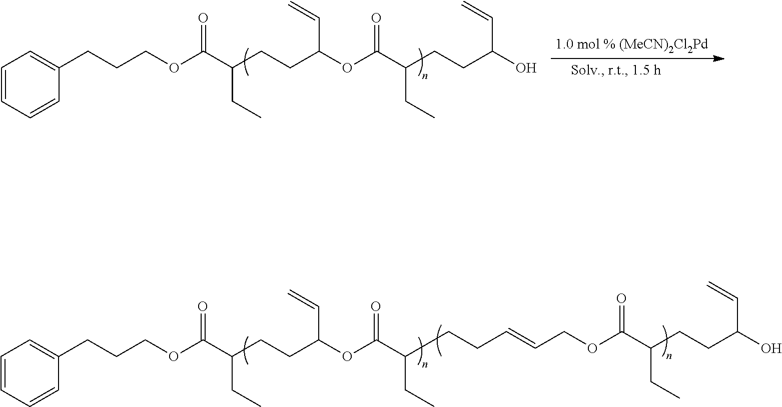

### Example 2—Preparation of PE2

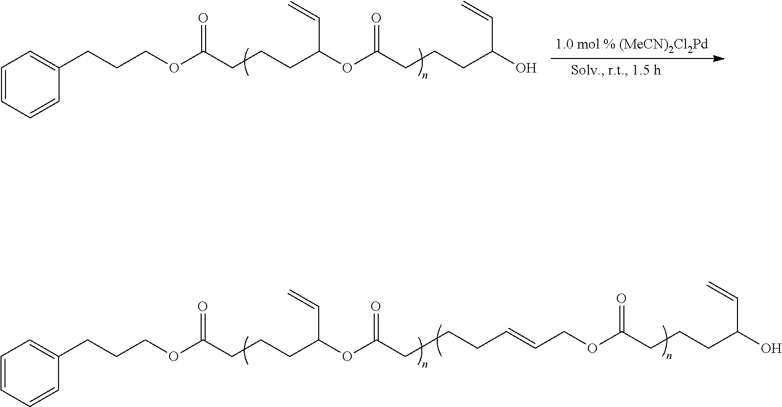

### Example 3—Preparation of PE3′

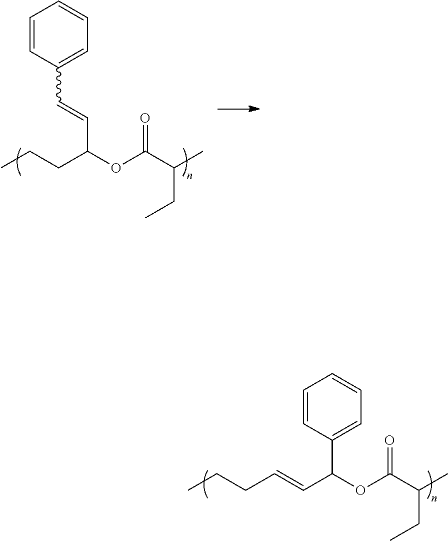

### Example 4—Preparation of PE4′

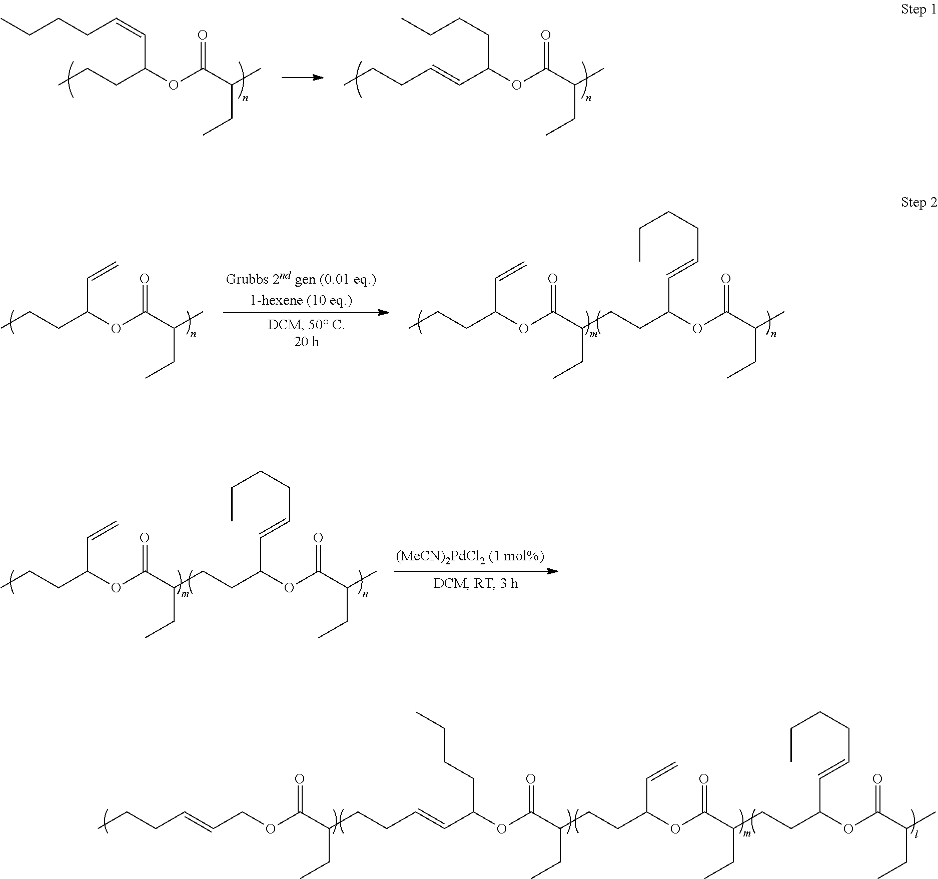

### Example 5—Preparation of PE5′

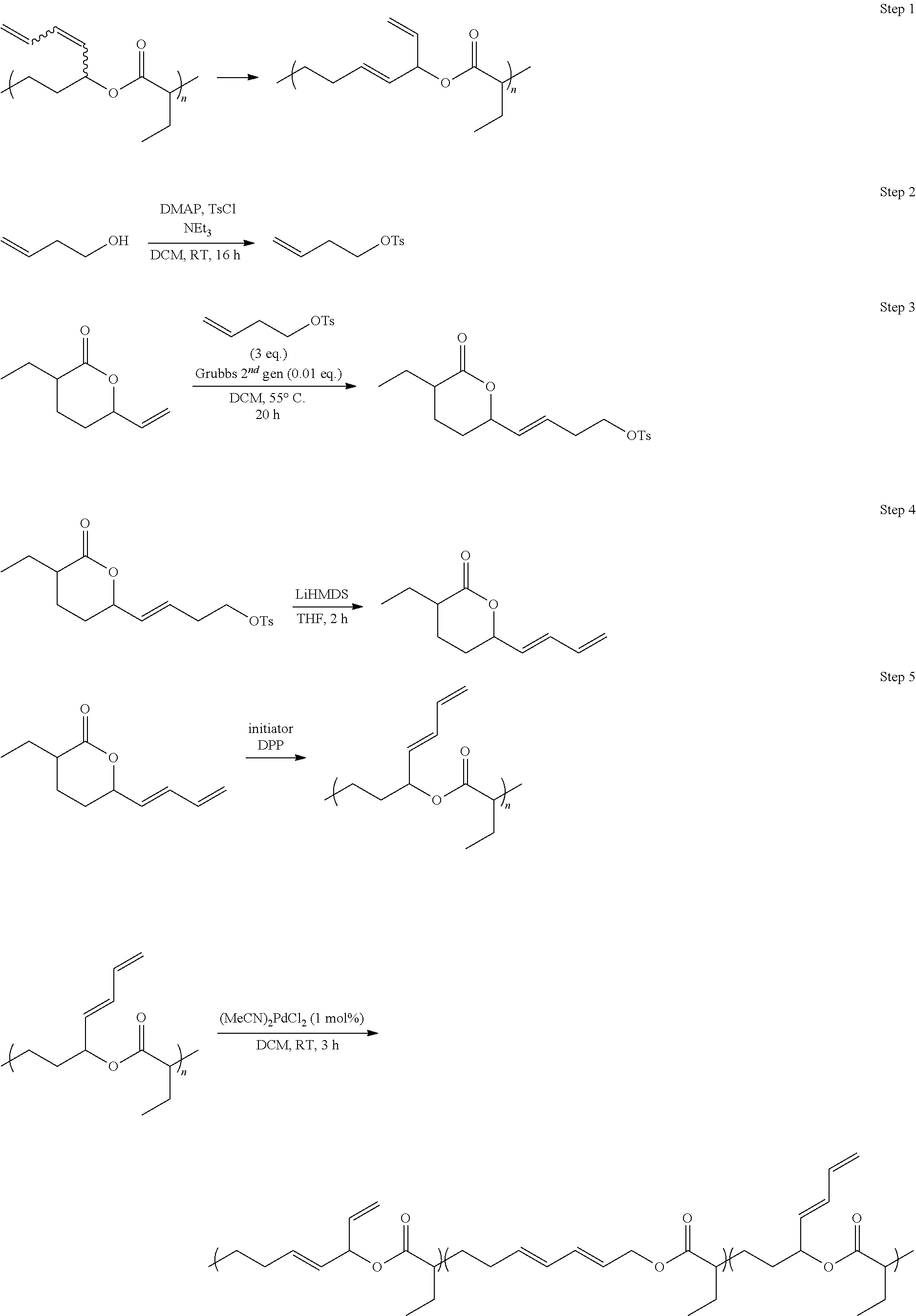

### Example 6—Preparation of PE6′

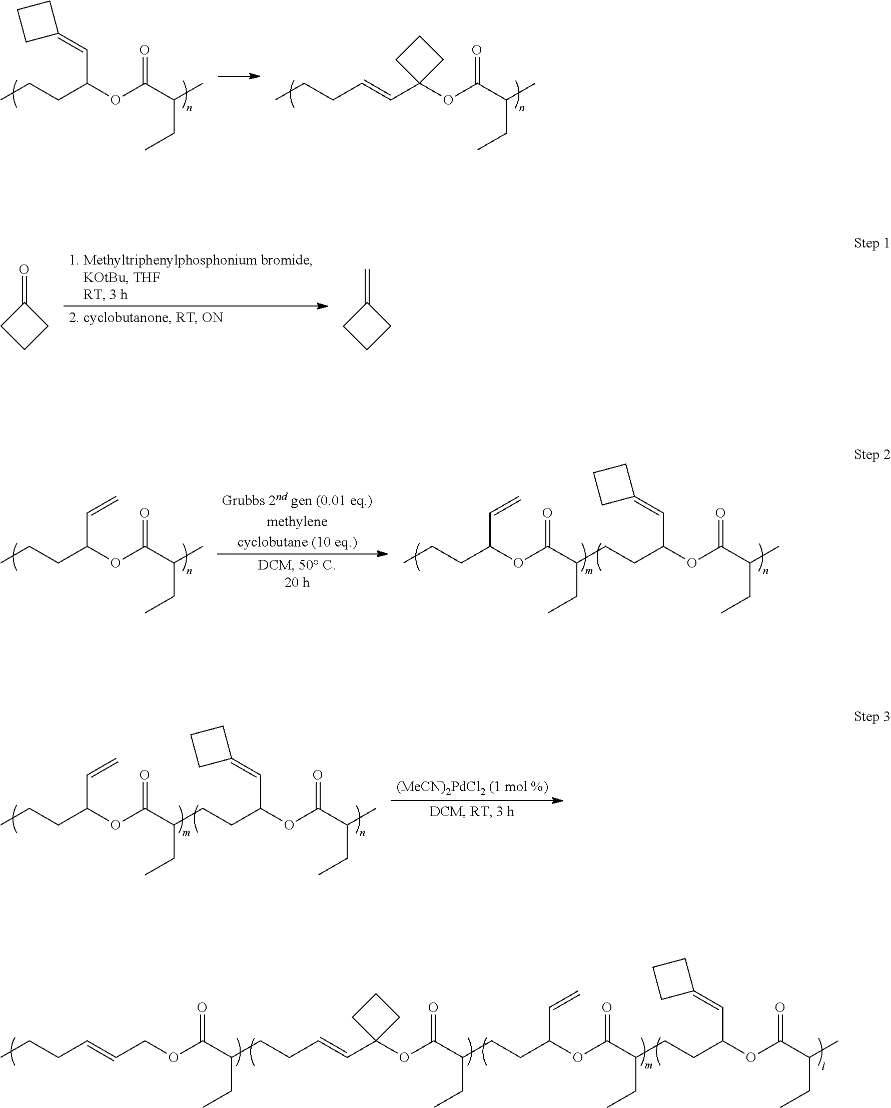

### Example 7—Preparation of PE7′

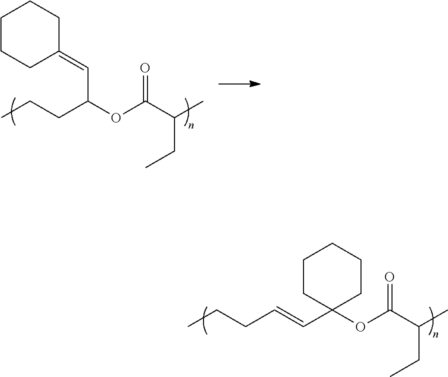

### Example 8—Preparation of PE′ Compound

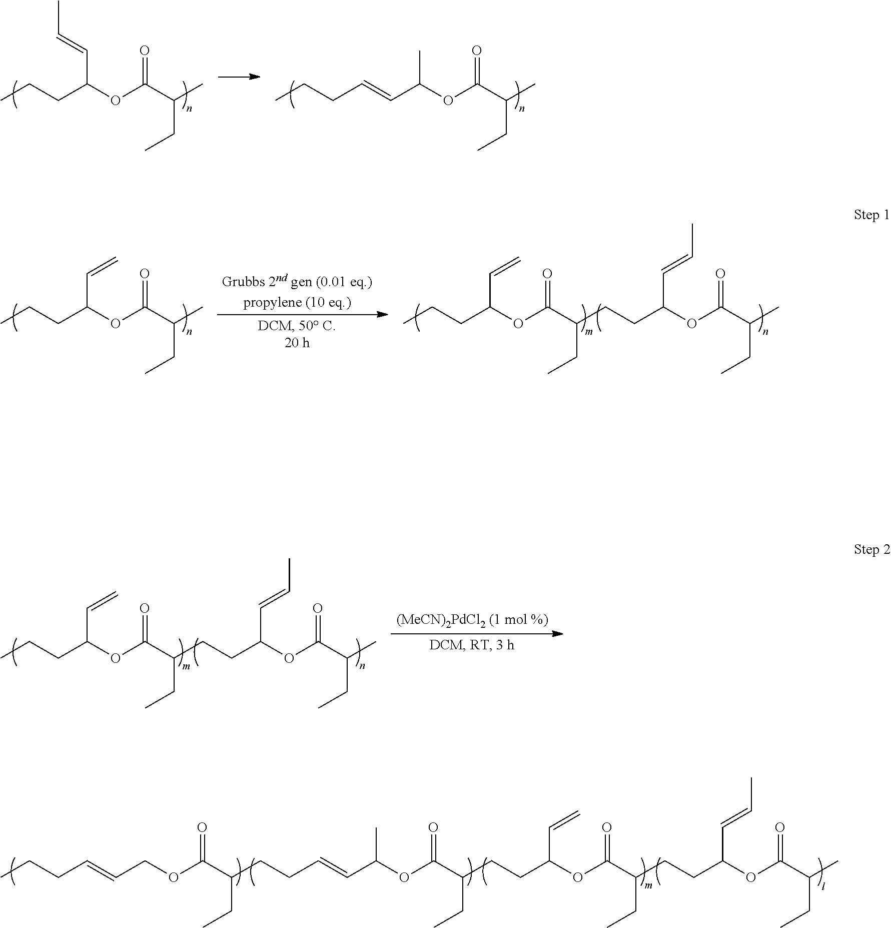

### Example 9—Preparation of PU1′ Compound

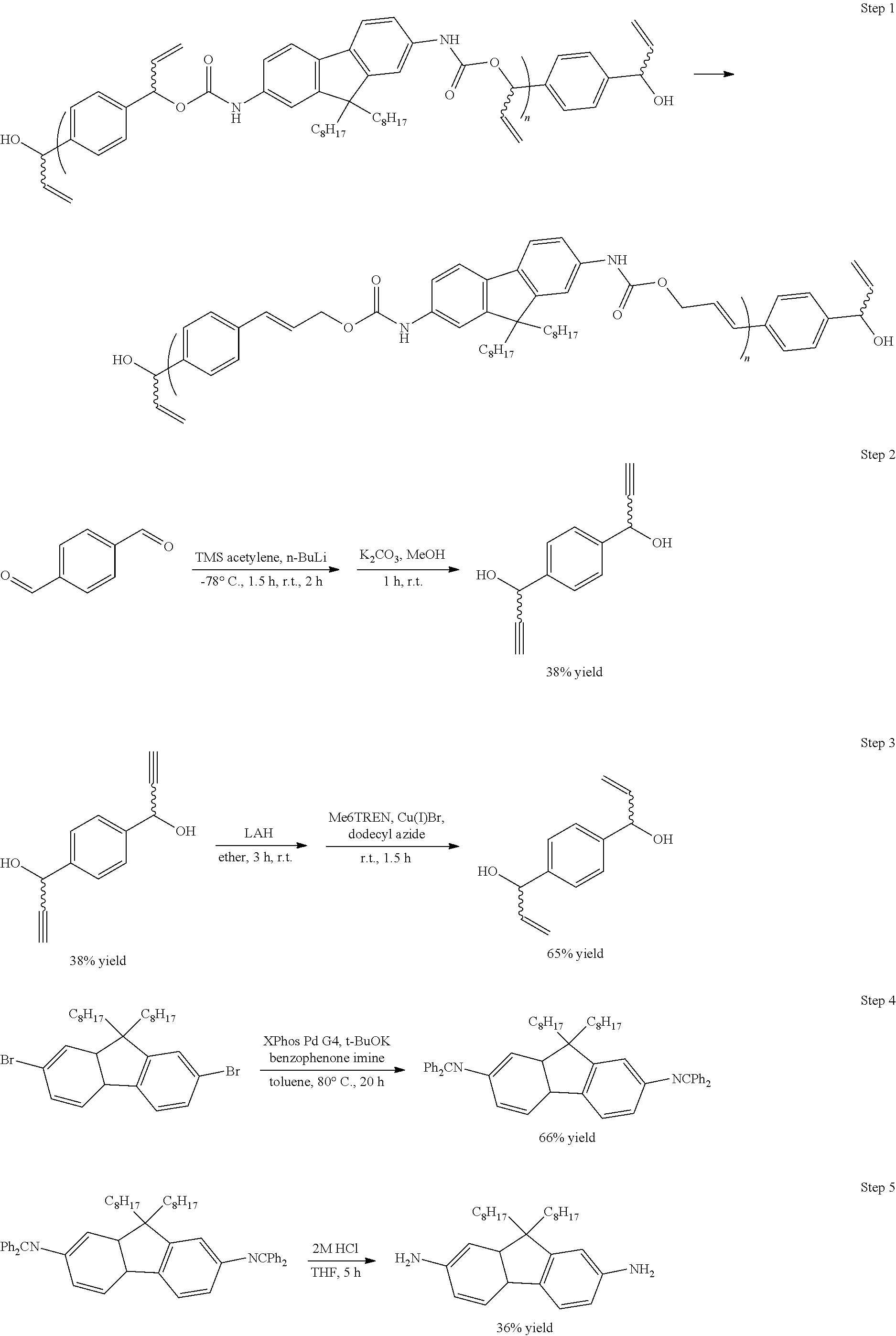

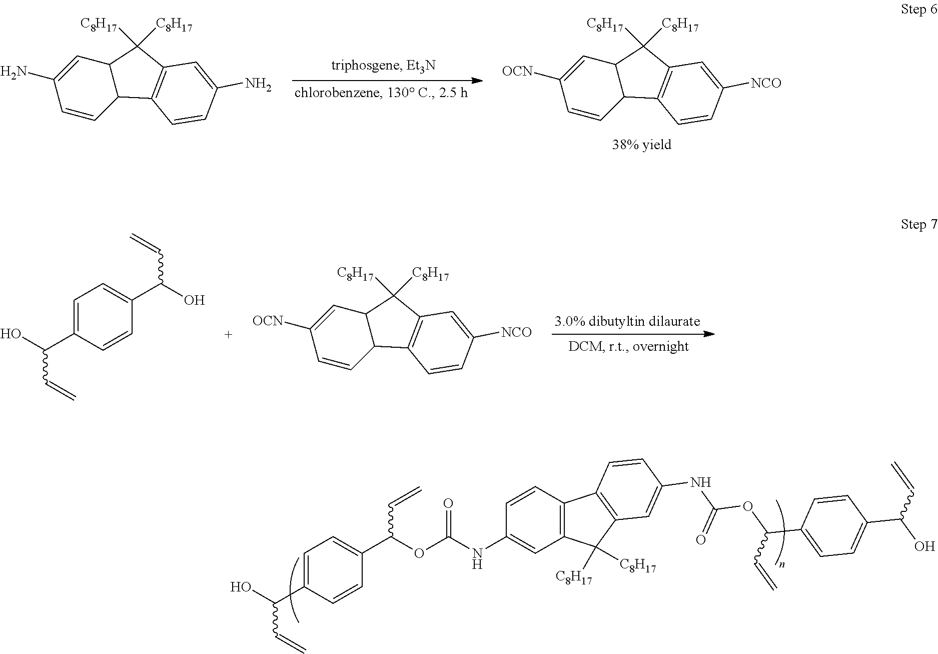

### Example 10—Preparation of PU2′ Compound

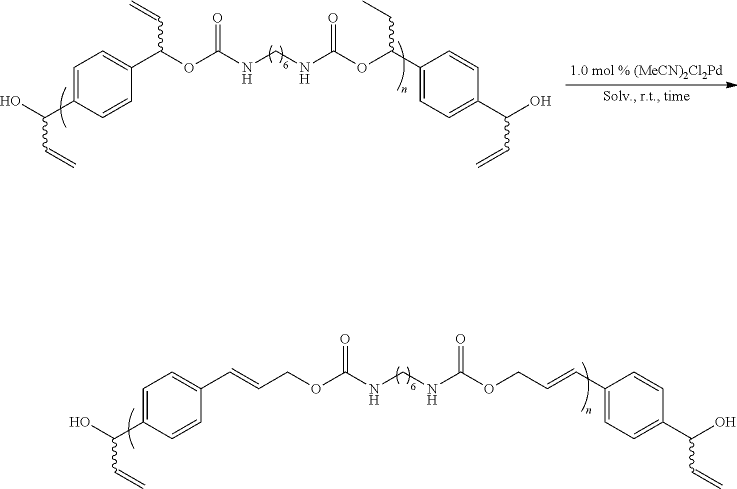

### Example 11—Preparation of PE′ Compounds

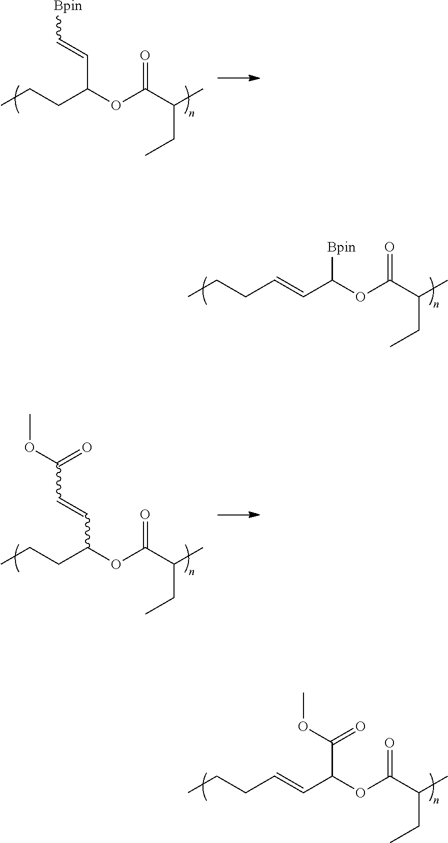

### Example 12—Ethenolysis of Rearranged Compounds

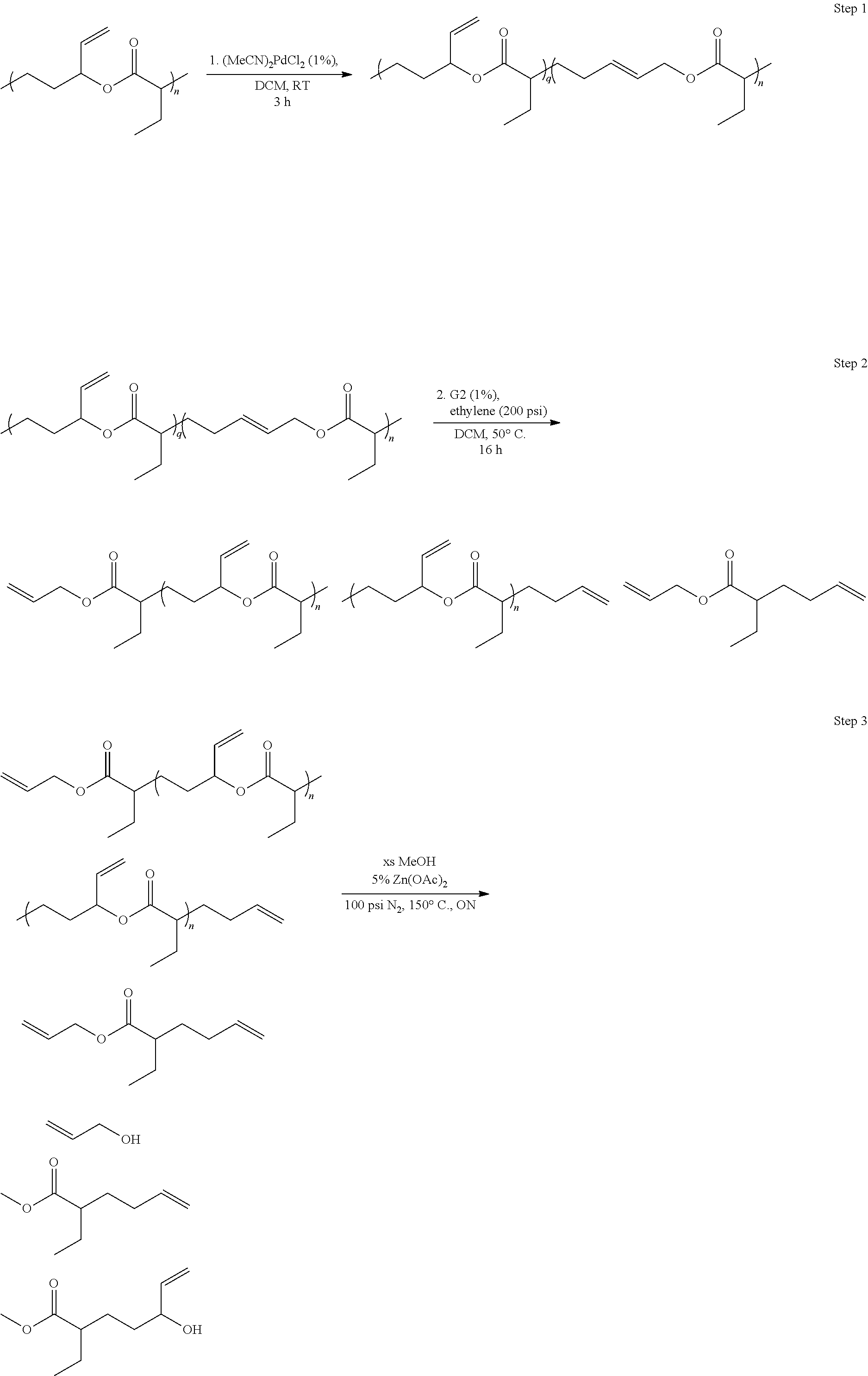

### Discussion of Examples 1-12

Polyesters PE1 and PE2 and polyurethanes PU1 and PU2 were selected as substrates for rearrangement reaction. The polyesters were previously prepared in the contexts of using CO₂ and butadiene as sustainable polymer precursors. See WO2022/187490 and U.S. 63/156,135, which are incorporated herein by reference in their entirety. Synthesis of PE1 (Mₙ=7.55 kDa, Ð=1.21) and PE2 (Mₙ, D) followed established protocols, and PU1 (Mₙ=24.6 kDa, Ð=1.40) and PU2 (Mₙ=4.2 kDa, Ð=1.57) were synthesized via di-n-butyltin(IV) dilaurate-catalyzed step-growth coupling of 1,4-phenylenebis(2-propen-1-ol) and either 9,9-di-n-octyl-9H-fluorene-2,7-diisocyanate or hexamethylene diisocyanate (HMDI), respectively, in dichloromethane (DCM) at 25° C. for 16 hours (see Examples).

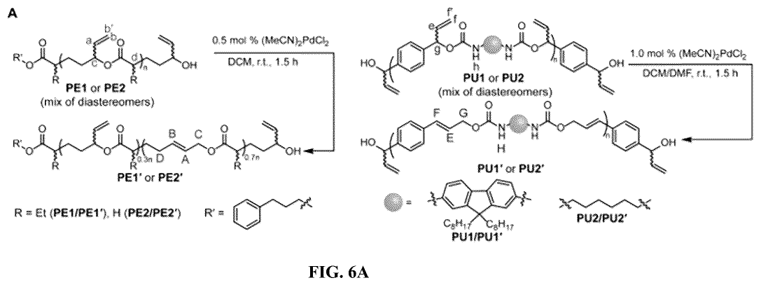

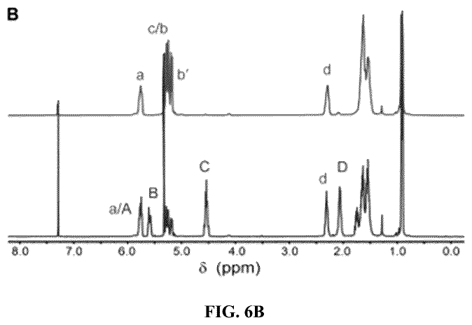

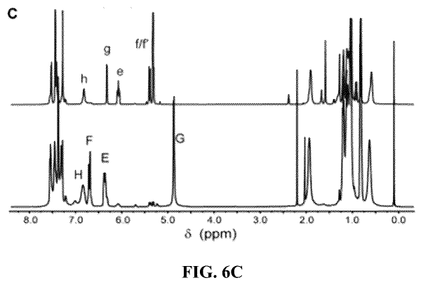

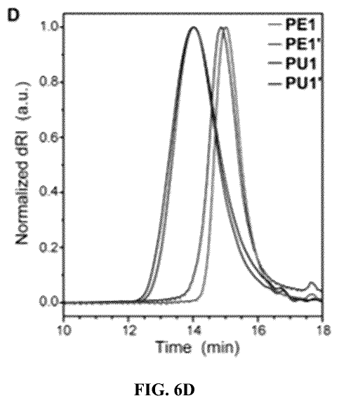

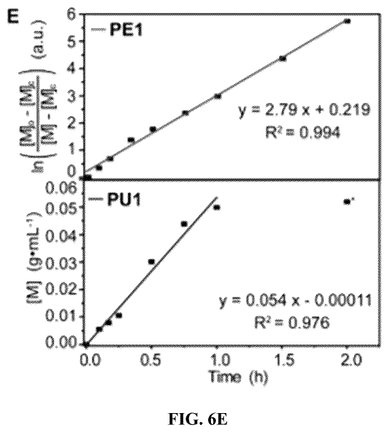

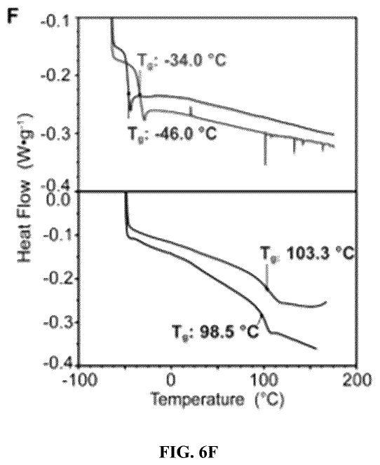

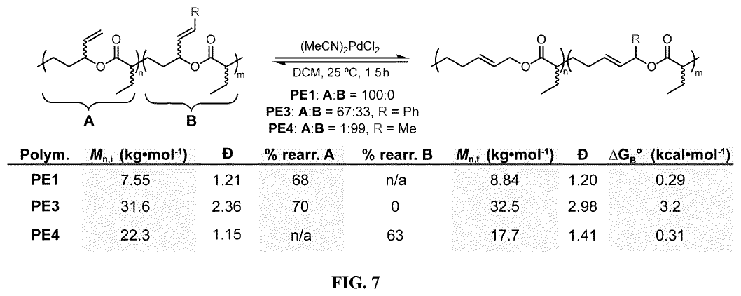

In a separate experiment, synthesis of PE1 (Mn=7.55 kDa, Ð=1.21, FIG. 6D) and PE2 (Mn=7.47 kDa, Ð=1.07) followed established protocols, and PU1 (Mn=22.3 kDa, Ð=1.63, FIG. 6D) and PU2 (Mn=14.4 kDa, Ð=1.66) were synthesized via di-n-butyltin(IV) dilaurate-catalyzed step-growth copolymerization of 1,4-phenylenebis(2-propen-1-ol) (3) and either 9,9-di-n-octyl-9H-fluorene-2,7-diisocyanate (4) or hexamethylene diisocyanate (HMDI), respectively, in dichloromethane (DCM) at 25° C. for 16 hours.

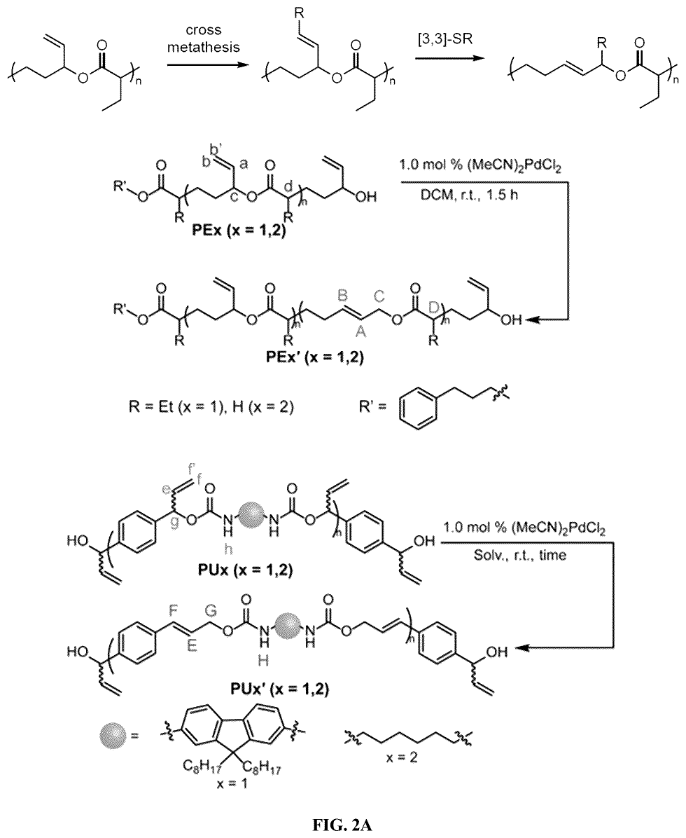

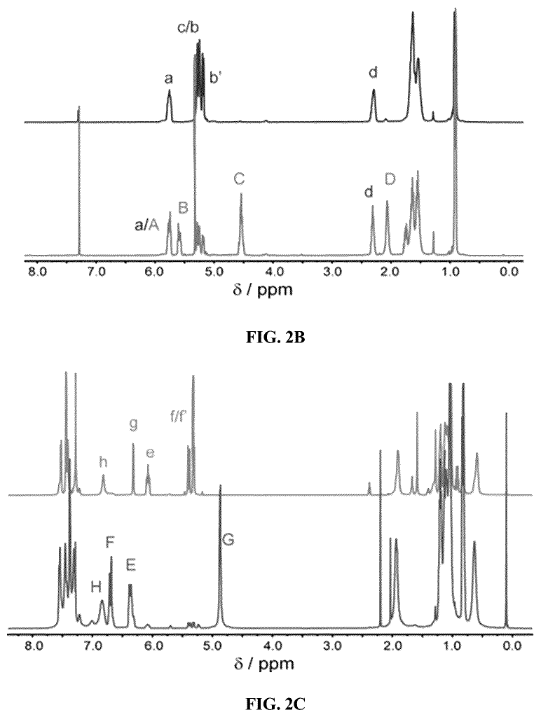

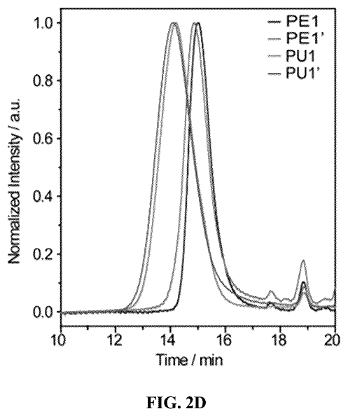

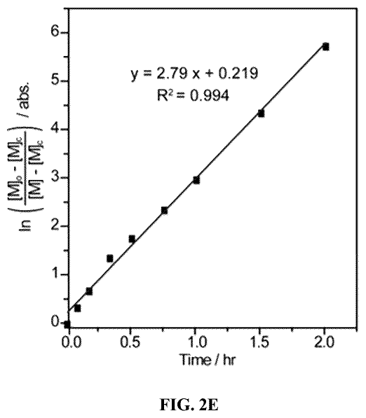

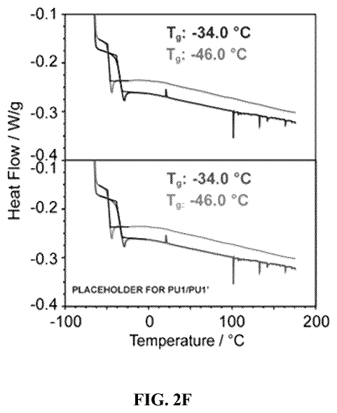

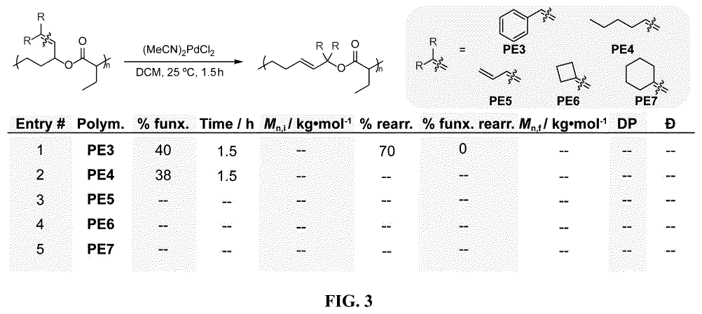

Subjection of PE1, PE2, PU1, and PU2 to 1 mol % (MeCN)₂PdCl₂ catalyst in dichloromethane (DCM) led to rapid rearrangement of the polymers from branched to linear (FIG. 2A). For PE1 and PE2, 66±X % conversion was achieved cleanly in 1.5 hours based on ¹H nuclear magnetic resonance (NMR) spectroscopy. In separate experiments, clean conversion (68.4±0.5% and 75±1%, respectively) was achieved in 1.5 hours based on ¹H nuclear magnetic resonance (NMR) spectroscopy (FIG. 6B; errors are standard deviations based on 5 and 3 trials, respectively). Fully linear PE2 was synthesized independently via polycondensation polymerization of methyl (Z)-7-hydroxyhept-5-enoate (5) and subjected to the same SOR conditions as PE2; this polymer achieved 33% conversion to the branched product PE2 as expected based on the conversion of the forward reaction, thus demonstrating the reversible nature of this SOR. For PU1, 96% conversion was achieved in 5 minutes, also with no side-reactivity (FIG. 2C). In separate experiments, 98% conversion was achieved in <2 hours, also with no side-reactivity (FIG. 6C). In contrast, PU2 only went to 35% conversion in DCM by ¹H NMR in 30 min—presumably, due to precipitation of the partially rearranged polymer. The resulting polyurethane was only soluble in DMF and DMSO, in which a final conversion of 50% to PU2′ was possible in DMF. In separate experiments, PU2 proceeded to ˜55% conversion by 1H NMR spectroscopy in 20 min, after which precipitation of the polymer was observed. 1H NMR characterization of the precipitated PU2′ redissolved in deuterated dimethyl sulfoxide (DMSO-d6) revealed a net 89% conversion of branched allylic carbamates to their linear isomers. Most of the Pd was removed from PU1′ and PU2′ during workup and from PE1′.

By GPC-MALS, the molar mass for PE1 and PE2 remained in good agreement with the original branched polyester (FIG. 2D), which indicated that chain cleavage does not take place, as expected based on the mechanism of the transformation (FIG. 1). In separate experiments, by GPC-MALS, the number-average molecular weights (Mn) of PE1′, PE2′, and PU1′ were nearly identical to those of the parent polymers (FIG. 6D), which confirms that chain cleavage does not take place, as expected based on the mechanism of SOR (FIG. 5). GPC-MALS was not obtained for PU2′ due to poor solubility in solvents other than DMSO; however, the diffusion-ordered spectroscopy (DOSY) diffusion coefficient for the polymeric species did not change (2.15×10−7 cm2/s), which supports a lack of chain cleavage in this case as well.

For PU1, the molar mass doubled and the dispersity increased compared to starting polyurethane by GPC-MALS (FIG. 2D). Higher conversions in the case of PE1 and PE2 could not be reached by varying concentration, catalyst loading, or temperature, which indicates that the rearrangements are at thermodynamic equilibrium ratios at these conversions; reaction kinetics are also consistent with equilibration (FIG. 2E). The nearly quantitative conversion of PU2 is likely due to the thermodynamically favored migration of the alkene into conjugation with the benzene ring. Rearrangement kinetics for PU1 and PU2 are zero order in alkene (FIG. 6E), which is indicative of strong binding of the catalyst to the polymer substrate.

Ground state DFT calculations on the thermodynamic equilibrium for one representative repeat unit of PE1, PE2, PU1, and PU2, capped with methoxy groups or hydrogen atoms for polyurethanes and polyesters, respectively (FIG. 7, right column), are consistent with the experimental observations above (FIG. 6A-F). The calculated ΔG° of PE1 and PE2 are both close to 0 (0.29 kcal/mol and 0.11 kcal/mol, respectively), consistent with incomplete rearrangement, while PU1 (−6.9 kcal/mol) and PU2 (−1.5 kcal/mol) are driven to near-complete conversion based on the stability of the conjugated alkene. Additionally, such DFT methods can easily be used to predict the degree of rearrangement of other polymers (e.g. PE3 and PE4, vide infra), providing a useful tool for future polymer synthesis and modification.

After rearrangement of PE1 to PE1′, the decomposition temperature at 10% mass loss and beyond, Td,_{10%} increased by about 13° C. The glass transition temperature (Tg) decreased by about 12° C. after rearrangement (FIG. 2F). Without being bound by any theory, this decrease in Tg could be explained by the decrease in branching, as small branches generally pack together and restrict chain movement. A similar decrease in T_{g}(about 9° C. and about 14° C.) was observed for the rearrangement of PE2 to PE2′ and PU1 to PU1′ respectively.

Given these results, alkene substitution was used to tune the rearrangement efficiency/equilibrium, to further impact physical polymer property changes, and also to produce novel materials that could not be easily accessed via direct polymerization. To explore these possibilities, two synthetic strategies were employed to modify the PE′ platform: cross-metathesis of monomer (EtVP) followed by subsequent polymerization, or post-polymerization cross-metathesis of the parent polyester PE. Polymer PE5 was synthesized through the monomer cross-metathesis route, where cross metathesis of EtVP with homoallyl tosylate followed by elimination yielded a diene-appended lactone that could undergo ROTEP. Alternatively, polymers PE3, PE4, PE6, and PE7 were synthesized by cross metathesis with PE1 due to ease in polymer functionalization, purification, and to avoid potential issues associated with ring-opening transesterification polymerization (ROTEP) of functionalized EtVP. A functionalized polyester containing functional groups that could undergo multiple rearrangements (R=diene) observed a variety of rearrangement products, as expected. The rearrangement of polyesters functionalized with rings (R=cyclobutyl, cyclohexyl) proceeded smoothly despite converting from a trisubstituted to disubstituted double bond, likely due to release of ring strain. The rearranged materials experienced a decrease in T_{g} similar to the parent materials.

In separate experiments to explore these possibilities, cross-metathesis of the parent polyester, PE1, was employed with styrene and 2-butene to afford PE3 and PE4 respectively (Figures). The styrenyl-functionalized esters in PE3 do not rearrange. As an internal control, the non-functionalized (R═H) repeat units in PE3 underwent 70% rearrangement, consistent with the previously established thermodynamics of the PE1-to-PE1′ rearrangement (FIG. 7). The propenyl-functionalized esters in PE4 undergo rearrangement to a similar degree of conversion (63%) as the vinyl-functionalized ones in PE1 (FIG. 7). Ground state DFT calculations on the thermodynamic equilibrium are consistent with experimental observations for PE3 and PE4 as well, with a calculated ΔG° of 3.2 kcal/mol and 0.31 kcal/mol respectively, consistent with no rearrangement and incomplete rearrangement (FIG. 7).

After rearrangement of PE1 to PE1′, the glass transition temperature (Tg) decreased by 12° C. (FIG. 6F), which is consistent with reduced branching. Similar decreases in Tg (13° C., 10° C., 3° C., and 5° C.) were observed for PE2/PE2′, PE3/PE3′, PE4/PE4′, and PU1/PU1′, respectively (FIG. 6F). Although the % conversion to “linear” is higher for PU1′ compared to all of the polyesters, the smaller shift in Tg than might be expected is most likely due to the dilution of the effects by the unchanged di-n-octylfluorene fragments. The Tg of PU2 observed at 64° C. is not observed below the decomposition temperature of PU2′ (Td,1%=195° C.). Increased hydrogen bonding and π-stacking in the more linearized architecture could explain the disappearance of Tg. Powder X-ray diffraction (PXRD) confirms a new chain packing pattern for PU2′ compared to PU2. The major observed peaks for PU2 and PU2′ with d-spacings of 4.54 Å and 4.08 Å respectively are consistent with hydrogen bonding between polyurethane chains.

As a way to perform additional post-polymerization modification, PE1′ and PE2′ were hydrogenated using Pd/C. Degradation of rearranged PE1 does not occur in the presence of Pd(0) and 84% conversion to saturated PE1′ was achieved with Pd/C. This modification served to further decrease the T_{g}s and led to polymers that predominantly resembled saturated polyesters derived from 8-membered lactones.

Thermal stabilities of PE1-PE4 and their rearranged counterparts PE1′-PE4′ proved to be nearly identical: for instance, the decomposition temperature at 5% mass loss, Td, 5%, of PE1′ was only 4° C. smaller than that of PE1. A similar trend was observed for PU2/PU2′ with post-rearrangement reduction in T_{d,5%} of 2° C. A bigger change in the opposite direction was observed for PU1/PU1′: T_{d,5%} of PU1′ was 31° C. greater than that of PU1; however, beyond this first stage, further mass loss for PU1 and PU1′ was virtually identical (Figure S84).

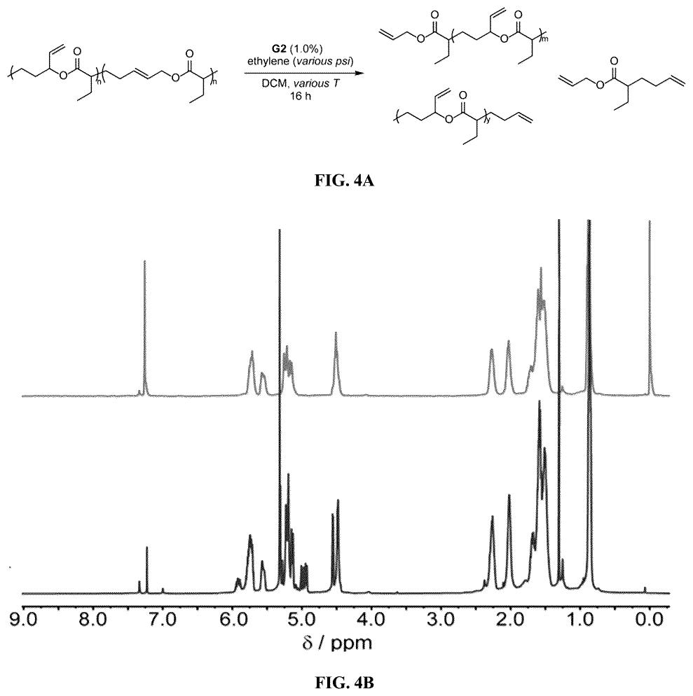

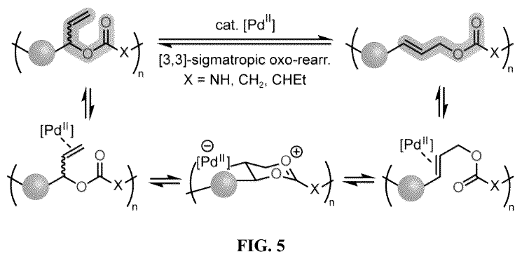

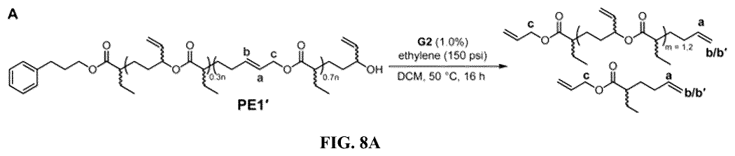

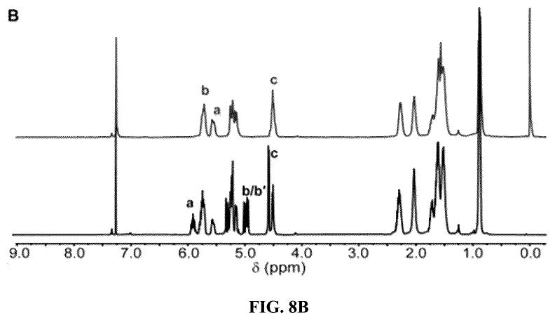

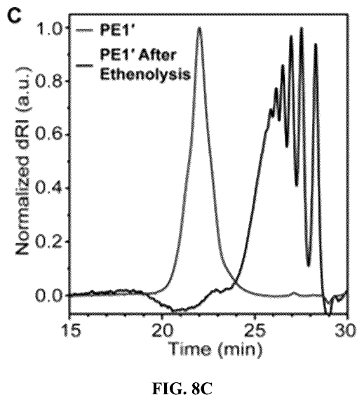

Another valuable feature of this rearrangement is the introduction of the alkene into the polymer backbone itself. This functionality provides a handle for facile depolymerization via ethenolysis (see examples). Using the parent PE1 as a model system, rearrangement was performed under the standard conditions (vide supra), then, without purification, exposed it to 2^{nd}-generation Grubbs catalyst (G2) and ethylene gas. Fragmentation of the polymer backbone was supported by both ¹H NMR spectroscopy (FIG. 4)—generation of terminal olefin resonances—and a dramatic decrease in Mₙ by GPC-MALS. The viability of this procedure demonstrated that (MeCN)₂Cl₂Pd does not interfere with G2 during ethenolysis. These reaction sequences demonstrated a straightforward way to selectively depolymerize PE1 through a 2-step, 1-pot reaction sequence, in addition to the previously shown chemical recycling and biodegradation pathways that are possible. Such a sequence is a valuable tool for the selective depolymerization and separation of PE1 or other α-vinyl sidechain polyesters in the presence of mixed polyester waste streams, which typically all undergo hydrolysis or catalyzed ring-closing depolymerization. In another experiment, rearrangement was first performed under standard conditions (described herein) and then, without purification, exposed it to 2nd-generation Grubbs catalyst (G2, 1 mol %) and ethylene gas (150 psi, 50° C., 16 hours, FIG. 8A). Fragmentation of the polymer backbone was observed by both ¹H NMR spectroscopy (FIG. 8B) and by a dramatic decrease in Mₙ by GPC-MALS (FIG. 8C). PE1 remains unchanged under standard ethenolysis conditions prior to the rearrangement.

To demonstrate broader utility of architectural editing, another polyurethane, PU3 (Mn=5.05 kDa, Ð=1.40), was synthesized directly from commercial starting materials 1,5-hexadiene-3,4-diol and HMDI to afford a polymer that both contains the allylic carbamate sigmatropomer and whose production can be readily scaled up. Rearrangement of PU3 was achieved using mol % (MeCN)₂PdCl₂ at 40° C. to afford PU3′ with ˜76% rearranged allylic carbamates, of which 66% formed internal 1,3-dienes, and the other 10% external 1,3-dienes (FIGS. 5A and S97-S101). W Without being bound by any theory or mechanism, it is hypothesized that higher temperatures and catalyst loadings are required for the rearrangement of PU3 compared to PU1 and PU2 because the resulting 1,3-dienes could poison the catalyst. Ground state DFT calculations on the thermodynamic equilibrium are consistent with experimental observations for PU3, with a calculated ΔG° of −4.4 kcal/mol and −2.9 kcal/mol for formation of the internal 1,3-diene and external 1,3-diene respectively. Most of the Pd was removed during workup (Table Si). Attempts to achieve higher conversion afforded an insoluble material. GPC-MALS was not obtained for PU3′ due to poor solubility in solvents other than DMSO; however, DOSY for PU3 and PU3′ affords the same diffusion coefficient (3.98×10−7 cm2/s) for the polymeric species (Figures S102-S103). Since PU3 and PU3′ have the same diffusion coefficient, we conclude that, as in other cases, this polymer remains intact throughout the SOR.

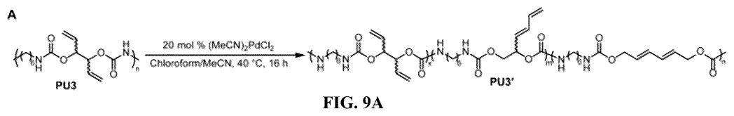

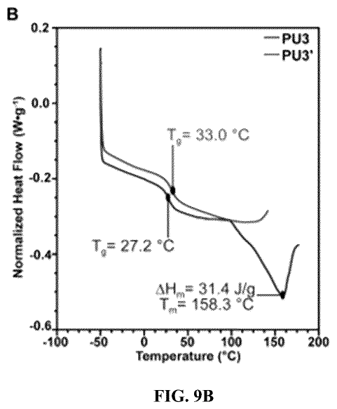

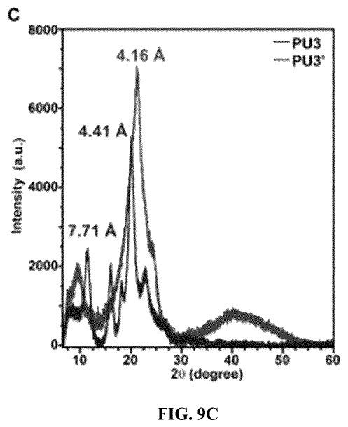

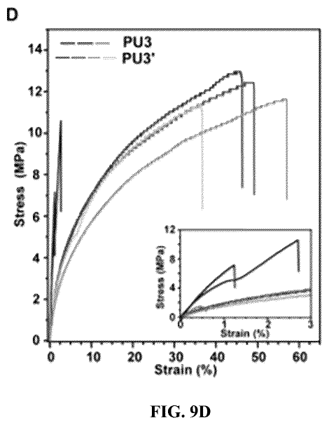

Compared to PU1 and PU2, rearrangement of PU3 leads to a substantially reduced Td,5% in PU3′ (from 228° C. to 164° C., Figure S104). Here, too, we think the key culprit is the presence of 1,3-dienes in the product. In addition to decreased thermal stability, PU3′ has a slightly increased Tg compared to PU3 (FIG. 9B). Furthermore, while PU3′ is a semicrystalline material, PU3′ is amorphous, as confirmed by both the disappearance of the melting transition in DSC traces and the simultaneous disappearance of some peaks and broadening of others in the PXRD traces (FIGS. 9B and 9C). The major observed d-spacing for PU3 and PU3′ (4.41 Å and 4.16 Å respectively) is consistent with hydrogen bonding between polyurethane chains (FIG. 9C).

Uniaxial tensile testing was performed on thin films of PU3 and PU3′ at a strain rate of 0.0042 Hz (12 mm sample length, 0.05 mm/s). PU3′ has a much higher strain at break (47±8%) and toughness (4.2±0.8 MPa) compared to PU3 (2±1% and 0.07±0.07 MPa respectively, FIG. 9D), but a lower Young's modulus (0.20±0.02 GPa compared to 0.7±0.2 GPa for PU3, FIG. 9D). Furthermore, PU3′ exhibits yielding behavior which could be due to facilitated chain slippage in the absence of crystalline domains. In short, the rearrangement leads in this case to a more amorphous and tougher material.

### Other Embodiments

It is to be understood that while the present application has been described in conjunction with the detailed description thereof, the foregoing description is intended to illustrate and not limit the scope of the present application, which is defined by the scope of the appended claims. Other aspects, advantages, and modifications are within the scope of the following claims.

1. A polymer compound comprising at least one repeating unit according to Formula (I) or Formula (II): 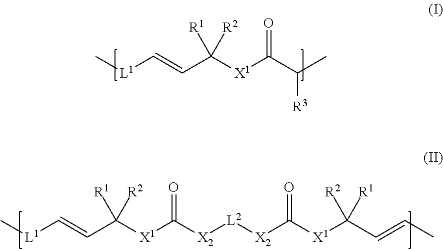
wherein:
each L¹ is independently selected from C₁₋₆ alkylene, C₆₋₁₀ arylene, C₃₋₁₀ cycloalkylene, 5-14 membered heteroarylene, and 4-10 membered heterocycloalkylene;
each L² is independently selected from C₁₋₁₂ alkylene, C₆₋₁₀ arylene, C₃₋₁₀ cycloalkylene, 5-14 membered heteroarylene, and 4-10 membered heterocycloalkylene,
each of which is optionally substituted with 1, 2, or 3 substituents independently selected from C₁₋₁₂ alkyl, halo, CN, C₁₋₆ haloalkyl, C₂₋₆ alkenyl, C₂₋₆ alkynyl, C(O)NR^{c1}R^{d1}, C(O)OR^{a1}, and C(O)R^{b1};
each X¹ is independently selected from O and NR^{N};
each X² is independently selected from O and NR^{N};
each R^{N} is independently selected from H and C₁₋₃ alkyl;
each R¹ is independently selected from H, Cy¹, halo, CN, C₁₋₆ alkyl, C₁₋₆ haloalkyl, C₂₋₆ alkenyl, C₂₋₆ alkynyl, C(O)NR^{c1}R^{d1}, C(O)OR^{a1}, C(O)R^{b1}, S(O)₂R^{b1}, S(O)₂NR^{c1}R^{d1}, S(O)₂OR^{a1}, P(O)(OR^{a1})₂, and B(OR^{a1})₂, wherein said C₁₋₆ alkyl is optionally substituted with Cy¹, halo, CN, C(O)NR^{c1}R^{d1}, C(O)OR^{a1}, C(O)R^{b1}, S(O)₂R^{b1}, S(O)₂NR^{c1}R^{d1}, S(O)₂OR^{a1}, or P(O)(OR^{a1})₂;
each R² is independently selected from H, Cy¹, halo, CN, C₁₋₆ alkyl, C₁₋₆ haloalkyl, C₂₋₆ alkenyl, C₂₋₆ alkynyl, C(O)NR^{c1}R^{d1}, C(O)OR^{a1}, C(O)R^{b1}, S(O)₂R^{b1}, S(O)₂NR^{c1}R^{d1}, S(O)₂OR^{a1}, P(O)(OR^{a1})₂, and B(OR^{a1})₂, wherein said C₁₋₆ alkyl is optionally substituted with Cy¹, halo, CN, C(O)NR^{c1}R^{d1}, C(O)OR^{a1}, C(O)R^{b1}, S(O)₂R^{b1}, S(O)₂NR^{c1}R^{d1}, S(O)₂OR^{a1}, or P(O)(OR^{a1})₂;
or R¹ and R² together with the carbon atom to which they are attached form a C₃₋₁₀ cycloalkyl ring or a 4-10 membered heterocycloalkyl ring, each of which is optionally substituted with 1 or 2 substituents independently selected from halo, CN, C₁₋₃ alkyl, C₁₋₃ haloalkyl, C(O)NR^{c1}R^{d1}, and C(O)OR^{a1};
R³ is selected from H and C₁₋₃ alkyl;
each Cy¹ is independently selected from C₆₋₁₀ aryl, C₃₋₁₀ cycloalkyl, 5-10 membered heteroaryl, and 4-10 membered heterocycloalkyl, each of which is optionally substituted with 1 or 2 substituents independently selected from R^{Cy};
each R^{Cy} is independently selected from halo, C₁₋₃ alkyl, C₁₋₃ haloalkyl, halo, CN, NO₂, C₁₋₃ alkoxy, C₁₋₃ haloalkoxy, amino, C₁₋₃ alkylamino, di(C₁₋₃ alkyl)amino, carboxy, and C₁₋₃ alkoxycarbonyl;
each R^{a1}, R^{b1}, R^{c1}, and R^{d1} is independently selected from H, C₁₋₃ alkyl, and C₁₋₃ haloalkyl; and
any two adjacent R^{a1} together form C₂₋₈ alkylene, C₆₋₁₀ arylene, C₃₋₁₀ cycloalkylene, 5-14 membered heteroarylene, or 4-10 membered heterocycloalkylene.

2. The polymer compound of claim 1 comprising at least one repeating unit of Formula (I):

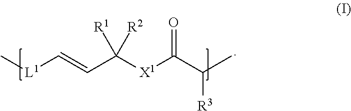

3. The polymer compound of claim 2, comprising at least one repeating unit of Formula (IA):

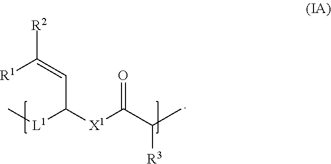

4. (canceled)

5. (canceled)

6. The polymer compound of claim 1, wherein X¹ is O.

7. The polymer compound of claim 1, wherein X¹ is NH.

8. The polymer compound of claim 2 comprising at least one repeating unit of formula:

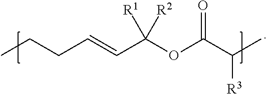

9. The polymer compound of claim 8 comprising at least one repeating unit of formula:

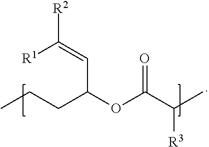

10. The polymer compound of claim 1, wherein R³ is H.

11. The polymer compound of claim 1, wherein R³ is C₁₋₃ alkyl.

12-14. (canceled)

15. The polymer compound of claim 2, wherein the repeating unit of Formula (I) is selected from any one of the following formulae:

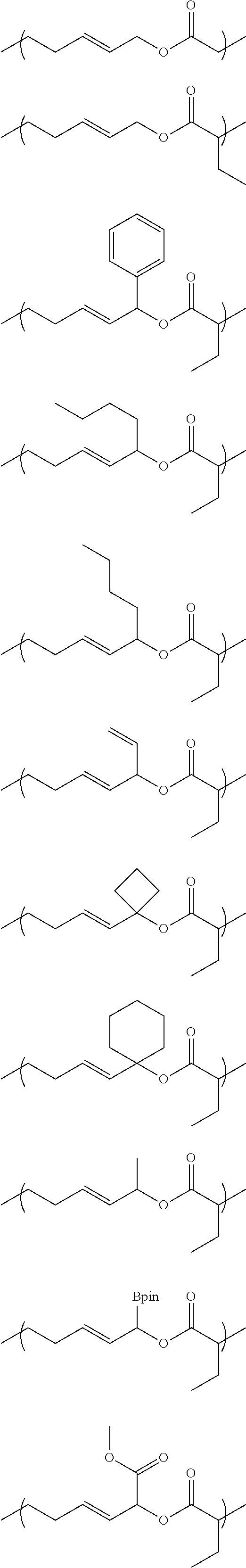

16. The polymer compound of claim 15, comprising a repeating unit of any one of the following formulae:

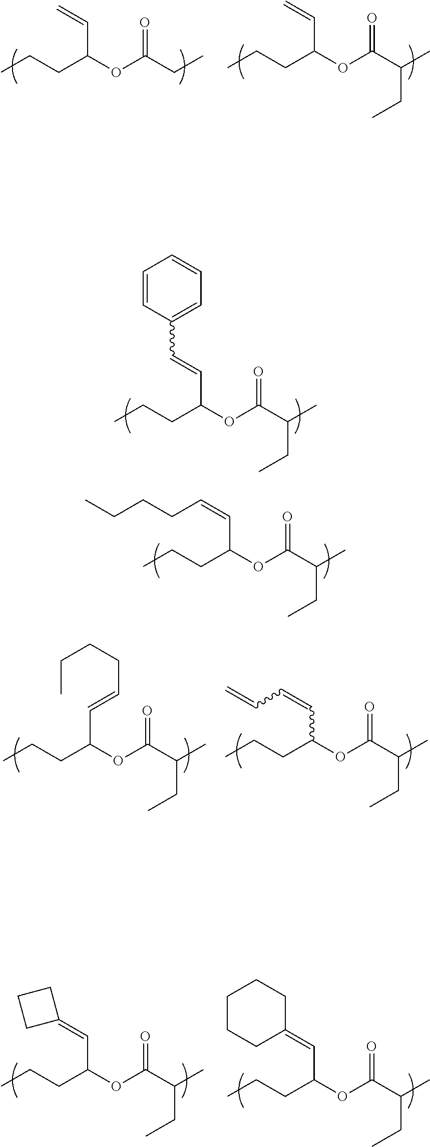

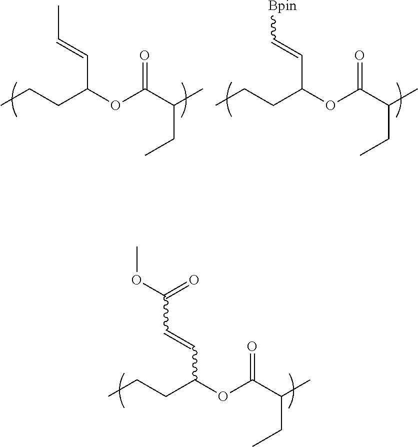

17. The polymer compound of claim 1 comprising at least one repeating unit of Formula (II):

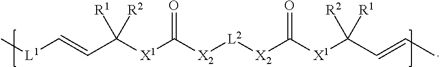

18. The polymer compound of claim 17, comprising at least one repeating unit of Formula (IIA):

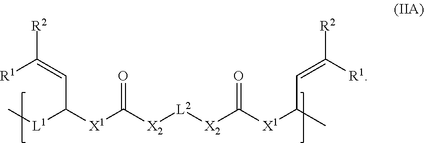

19-22. (canceled)

23. The polymer compound of claim 17, wherein X¹ is O.

24-26. (canceled)

27. The polymer compound of claim 17 comprising at least one repeating unit of formula:

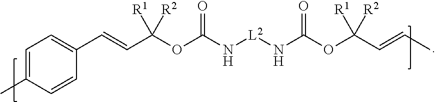

28. The polymer compound of claim 8 comprising at least one repeating unit of formula:

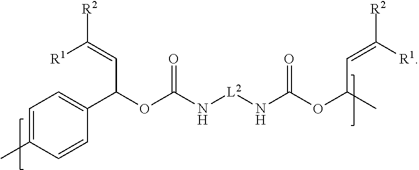

29-35. (canceled)

36. The polymer compound of claim 17, wherein the repeating unit of Formula (II) is selected from any one of the following formulae:

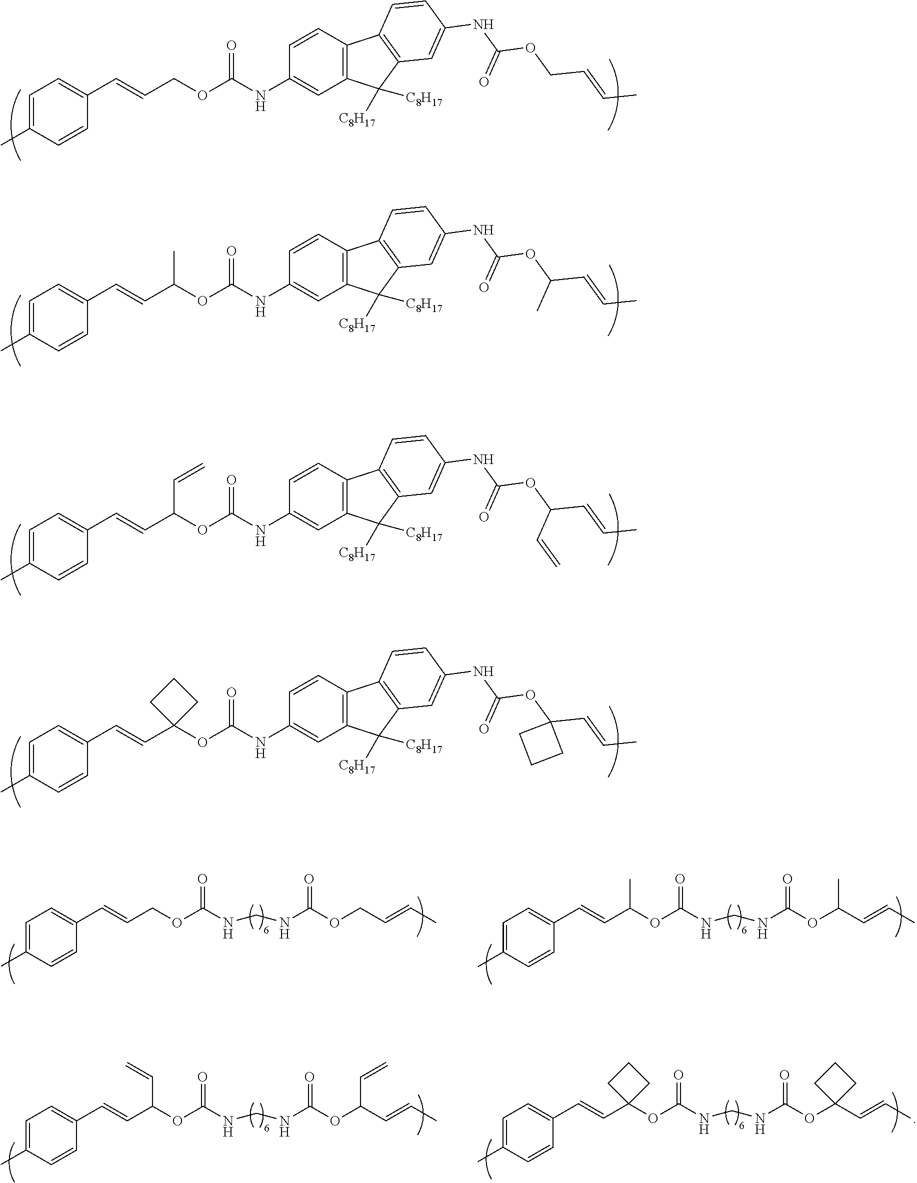

37. The polymer compound of claim 36, comprising a repeating unit of any one of the following formulae:

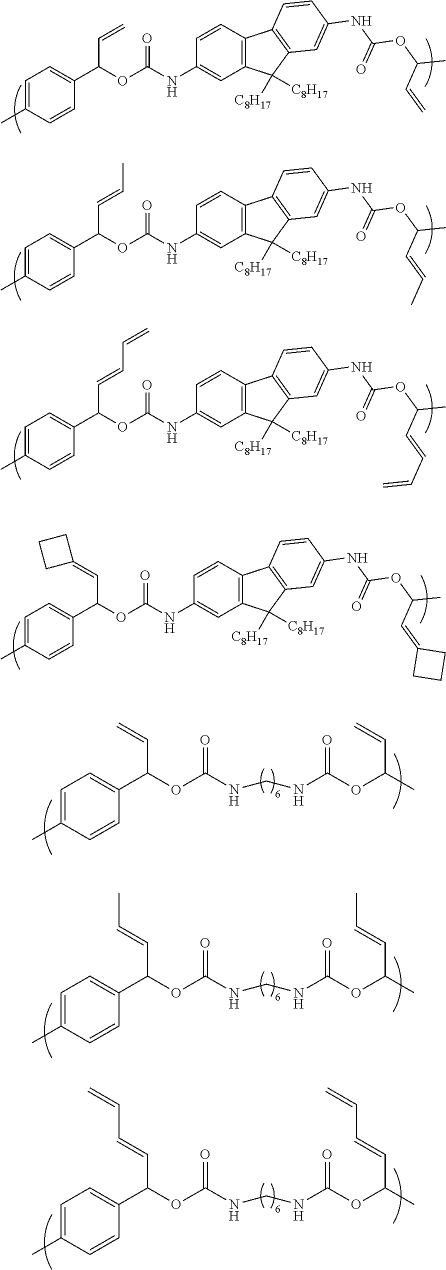

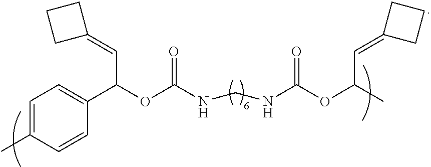

38. A method of making a polymer compound comprising at least one repeating unit of Formula (I): 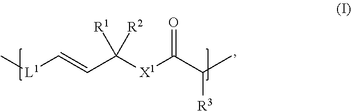
the method comprising reacting a compound of Formula (IA): 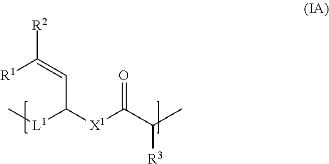
to obtain the compound of Formula (I),
wherein L¹, R¹ R², X¹, and R³ in Formulae (I) and (IA) are as defined in any one of claims 1-16.

39. A method of making a polymer compound comprising at least one repeating unit of Formula (II): 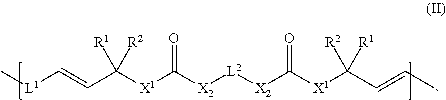
the method comprising reacting a compound of Formula (IIA): 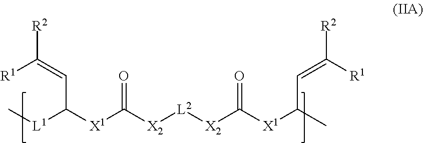
to obtain the compound of Formula (II),
wherein L¹, R¹ R², X¹, X², and L² in Formulae (II) and (IIA) are as defined in any one of claims 17-37.

40-45. (canceled)
